(19) United States
(12) Patent Application Publication
(10) Pub. No.: US 2026/0330446 A1
(43) Pub. Date: Oct. 22, 2026

(54) SYSTEMS AND METHODS FOR GENERATING AND USING PAYMENT TOKENS

(71) Applicant: Capital One Services, LLC, McLean, VA (US)

(72) Inventors: Jeffrey Carlyle Wieker, Falls Church, VA (US); Austin Fuglestad, Frederick, VA (US); Madeline Riese, Brooklyn, NY (US)

(73) Assignee: Capital One Services, LLC, McLean, VA (US)

(21) Appl. No.: 19/182,769

(22) Filed: Apr. 18, 2025

(51) Int. Cl. G06Q 20/36; G06Q 20/32; G06Q 20/34

(52) U.S. Cl. CPC G06Q 20/363; G06Q 20/3255; G06Q 20/341; G06Q 20/352

(57) ABSTRACT

Systems and methods for generating and using payment tokens are provided. An exemplary method comprising receiving, from a merchant device, a request to create one or more payment tokens associated with a personal identifier of a user, and creating the one or more payment tokens without a payment instrument attached. The method further comprises transmitting, to the merchant device, the one or more payment tokens, transmitting, to a payment facilitator device, a request of payment information of one or more payment instruments of the user, and receiving, from the payment facilitator device, the payment information of the one or more payment instruments. The method further comprises associating, by the application, the payment information with the one or more payment tokens, and storing the payment information and the one or more payment tokens in a token data store.

### FIELD OF THE DISCLOSURE

The present disclosure relates generally to tokenization technology and, more specifically, to systems and methods for generating and using payment tokens.

### BACKGROUND

Payment tokenization is a security technique of replacing sensitive data with non-sensitive ones. For example, a credit card number is replaced with a unique, random set of characters called a “token.” Payment tokenization can facilitate keeping payment data safe during transactions, because the actual card information is not being used or stored, such as a card's primary account number (PAN).

By using payment tokens, merchants can provide a secure and seamless payment experience for users while reducing the risk of data breaches and fraud. However, conventional payment tokens are usually created during a transaction or after a transaction, which can delay transaction speed, reduce transaction efficiency, and adversely impact user's shopping experiences.

These and other deficiencies exist. As such, there is a need for an improved system and method for generating and using payment tokens that promotes user convenience and speed up transactions.

### SUMMARY OF THE INVENTION

Aspects of the present application include systems and methods generating and using payment tokens.

In one aspect, a payment token system for generating and using payment tokens is provided. In some embodiments, the payment token system comprises a token creation device. The token creation device is configured to: receive, from a merchant device, a request to create one or more payment tokens associated with a personal identifier of a user, in response to the request, create the one or more payment tokens without a payment instrument attached to the one or more payment tokens, transmit the one or more payment tokens to the merchant device, transmit, to a payment facilitator device, a request of payment information of one or more payment instruments of the user, the request including the personal identifier of the user, receive, from the payment facilitator device, the payment information of the one or more payment instruments of the user, in response to receiving the payment information, associate the payment information of the one or more payment instruments of the user with the one or more payment tokens, and store the payment information of the one or more payment instruments of the user and the one or more payment tokens in a token data store.

In another aspect, a method for generating and using payment tokens is provided. In some embodiments, the payment token method can comprise: receiving, by an application executing on a token creation device from a merchant device, a request to create one or more payment tokens associated with a personal identifier of a user; in response to the request, creating, by the application, the one or more payment tokens without a payment instrument attached to the one or more payment tokens; transmitting, by the application to the merchant device, the one or more payment tokens; transmitting, by the application to a payment facilitator device, a request of payment information of one or more payment instruments of the user, the request including the personal identifier of the user; receiving, by the application device from the payment facilitator device, the payment information of the one or more payment instruments of the user; in response to receiving the payment information, associating, by the application, the payment information of the one or more payment instruments of the user with the one or more payment tokens; and storing, by the application, the payment information of the one or more payment instruments of the user and the one or more payment tokens in a token data store.

In yet another aspect, a non-transitory computer-readable storage medium for generating and using payment tokens is provided. The non-transitory computer-readable medium having computer-executable instructions stored thereon that, when executed by a token creation device comprising a processor, cause the token creation device to perform procedures comprising: receiving, from a merchant device, a request to create one or more payment tokens associated with a personal identifier of a user; in response to the request, creating the one or more payment tokens without a payment instrument attached to the one or more payment tokens; transmitting the one or more payment tokens to the merchant device; transmitting, to a payment facilitator device, a request of payment information of one or more payment instruments of the user, the request including the personal identifier of the user; receiving, from the payment facilitator device, the payment information of the one or more payment instruments of the user; in response to receiving the payment information, associating the payment information of the one or more payment instruments of the user with the one or more payment tokens; and storing the payment information of the one or more payment instruments of the user and the one or more payment tokens in a token data store.

Non-transitory computer program products (e.g., physically embodied computer program products) are also described that store instructions, which, when executed by one or more data processors (e.g., processor circuit) of one or more computing systems, cause at least one data processor to perform one or more of the operations herein. Similarly, computer systems are also described, which may include one or more data processors and memory coupled to the one or more data processors. The memory may temporarily or permanently store instructions that cause at least one processor to perform one or more of the operations described herein. In addition, methods can be implemented by one or more data processors, which are either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE SEVERAL VIEWS OF THE DRAWINGS

Provided below is a brief description of the several views of the drawings which illustrate various aspects of some embodiments of the present disclosure. The various drawings are described in more detail in the Detailed Description that follows.

FIG. 1 is a network diagram of an example system for generating and using payment tokens in accordance with embodiments discussed herein.

FIG. 2 illustrates an example sequence flow of the system in FIG. 1 in accordance with embodiments discussed herein.

FIG. 3 illustrates a flow chart of an example method of generating and using payment tokens in accordance with embodiments discussed herein.

FIG. 4 illustrates a flow chart of an example method of generating and using payment tokens in accordance with embodiments discussed herein.

FIG. 5 illustrates a flow chart of an example method of generating and using payment tokens in accordance with embodiments discussed herein.

FIG. 6 illustrates a flow chart of an example method of generating and using payment tokens in accordance with embodiments discussed herein.

FIG. 7 illustrates a block diagram of an example machine learning model for determining payment instruments and locations in accordance with embodiments discussed herein.

FIG. 8 illustrates a flow chart of an example method of determining payment instruments and locations in accordance with embodiments discussed herein.

FIG. 9 illustrates a block diagram of an example machine learning model for determining payment instrument information and step-up methods in accordance with embodiments discussed herein.

FIG. 10 illustrates a flow chart of an example method of determining payment instrument information and step-up methods in accordance with embodiments discussed herein.

FIG. 11 illustrates a block diagram of an example machine learning model for token ranking in accordance with embodiments discussed herein.

FIG. 12 illustrates a flow chart of an example method of token ranking in accordance with embodiments discussed herein.

FIG. 13 illustrates a flow chart of an example method of using payment tokens in accordance with embodiments discussed herein.

FIG. 14 illustrates a machine learning system in accordance with embodiments discussed herein.

FIG. 15 illustrates a machine learning apparatus in accordance with embodiments discussed herein.

FIG. 16 illustrates an artificial intelligence architecture in accordance with embodiments discussed herein.

FIG. 17 illustrates a computing architecture in accordance with embodiments discussed herein.

FIG. 18 illustrates a communications architecture in accordance with embodiments discussed herein.

### DETAILED DESCRIPTION

The following description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

Furthermore, the described features, advantages, and characteristics of the exemplary embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments. One skilled in the relevant art will understand that the described features, advantages, and characteristics of any embodiment can be interchangeably combined with the features, advantages, and characteristics of any other embodiment.

Described herein are exemplary systems and methods for generating and using payment tokens. The present invention is directed to the creation of one or more blank payment tokens for a user by a token creator prior to the purchase moment for provision to a merchant. The token creator communicates with a payment facilitator to obtain payment information of one or more payment instruments of the user and associate the payment information of one or more payment instruments to the corresponding one or more blank payment tokens. When the user checks out at the merchant (at a later time), the user is shown the one or more payment tokens of the user, and the user can select one of the one or more payment tokens for checking out. The token creator can use a machine learning model to rank the one or more payment tokens to place the preferable payment token on the top of the ranking, so the user is highly likely to select that payment token for checking out. The payment facilitator can also use a machine learning model to determine whether they want to transmit the payment information to the token creator and whether a step-up method is needed for a payment instrument. This invention addresses the technical problem of securely and speedily conducting merchant transactions by creating one or more payment tokens for a user in advance, so the user can check out securely and quickly. This invention can significantly improve card use experience of both users and merchants because of the secure and speedy transaction processing. Further, if a merchant could get a token without a specific payment attached to it at the start, other financial institutions can vie for the token to have their cards to associate with the token, which can allow the customer to pick which payment implement they want to pay with.

The tokens can be created by a token creator prior to a purchase moment and provided to a merchant. The merchant can ask the token creator for one or more tokens with a consumer's information. The user's information can be based on the user either signing in or singing up for a merchant account with the merchant using a phone number or email address of the user.

The token creator (e.g., a bank) can then create a token without a payment instrument attached to it for the merchant to store. The payment instrument can be a credit card or debit card with an associated network. At this time, the created token is a blank token associated to the token creator. The token creator can take the user's information to prove the identity of the user. With that information, the token creator can then communicate with payment facilitators (e.g., banks, digital wallets) to request payment instrument information of the user.

The payment facilitators can determine if they want to participate in sending the payment instrument information of the user. As described above, a payment instrument can be, without limitation, a credit card, a debit card, a bank account, a payment wallet, and a gift card. The payment facilitators may also determine whether a step-up authentication (e.g., a text message) is required for the payment instrument. Herein, a step-up authentication can be any additional information that the payment facilitators require to prove the identity of the user. The payment facilitators may create an artificial intelligence (AI) model to determine if they want to send the payment instrument information of the user to the token creator and what step-up authentication methods they might want.

If the payment facilitators determine they want to send the payment instrument information of the user to the token creator, the token creator receives all the payment instrument information of the user back from the payment facilitators. The token creator can then aggregate all the received payment instrument information and store it into a data storage. The token creator may also create a token ranking based on an AI modal of most. The token ranking can generate a token preferable list including tokens likely to be accepted and usage by the user. The token creator can then inform the merchant that the token creator has payment instrument information of the user. The payment instrument information may include credit card numbers, expiration dates, card verification values, cardholder names, bank account numbers, and so forth.

The merchant can at any point, for example, around checkout, tell the user about all the tokens associated with the user the merchant got back and what those tokens may be like. For example, a token can be a blank token without a payment instrument associated with; a token may require multiple different step-up authentications; a token may require a short message service (SMS) message authentication; a token may require a one-time passcode authentication; and a token may not require a step-up authentication at all. If multiple cards do not require step-up authentication, the user can select one of the multiple cards to check out. In some embodiments, the merchant may be capable of sorting the tokens based on an AI selection for optimal token, best use token, and token with best ability to be approved.

In some embodiments, the token creator may connect to servers and utilize AI/machine learning (ML) to determine if the user has payment instruments and where those instruments are located. The token creator may be able to communicate with both merchants and payment facilitator synchronously and/or asynchronously.

In some embodiments, a merchant (e.g., any online or in-store retailer) may have an online store that can communicate asynchronous to the token creator. The merchant may have a way to track who the user on their website is, information about the user (e.g., IP address, location, email or phone number). The merchant may be configured to step up the user in many different ways. The merchant may be configured to show the user all the payment instruments that are returned from the token creator and allow the user to select which one they want.

In some embodiments, the payment facilitators may be configured to take in sporadic information and make an information-based decision on if and what to return to the merchant.

The present disclosure can streamline and make the checkout experience (e.g., online shopping) more efficient with payment tokens.

With general reference to notations and nomenclature used herein, one or more portions of the detailed description which follows may be presented in terms of program procedures executed on a computer or network of computers. These procedural descriptions and representations are used by those skilled in the art to most effectively convey the substances of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, desirable, or even possible in most cases, in any of the operations described herein that form part of one or more embodiments. Rather, these operations are machine operations. Useful machines for performing operations of various embodiments include digital computers as selectively activated or configured by a computer program stored within that is written in accordance with the teachings herein, and/or include apparatus specially constructed for the required purpose or a digital computer. Various embodiments also relate to apparatus or systems for performing these operations. These apparatuses may be specially constructed for the required purpose. The required structure for a variety of these machines will be apparent from the description given.

In the following description, for the purpose of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modification, equivalents, and alternatives within the scope of the claims.

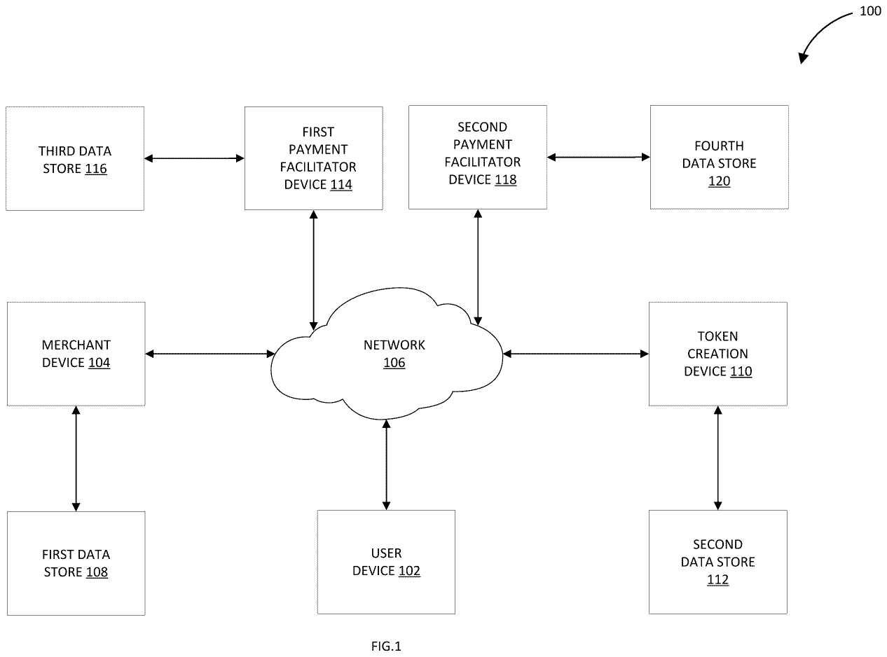

FIG. 1 illustrates system 100 for generating and using payment tokens according to an example embodiment. As further discussed below, system 100 may include user device 102, merchant device 104, network 106, first data store 108, token creation device 110, second data store 112, first payment facilitator device 114, third data store 116, second payment facilitator device 118, and fourth data store 120. Although FIG. 1 illustrates single instances of the components, system 100 may include any number of components.

System 100 may include user device 102 that may be in communication with merchant device 104 over network 106. User device 102 may be associated with a user and may be used with merchant device 104 to authenticate the user as one or more authentication factor. User device 102 may include an iPhone, iPod, iPad from Apple® or any other mobile device running Apple's iOS® operating system, any device running Microsoft's Windows® mobile operating system, any device running Google's Android® operating system, and/or any other smartphone, tablet, or like wearable mobile device. User device 102 may include processing circuitry and may contain additional components, including processors, memories, error and parity/CRC checkers, data encoders, anticollision algorithms, controllers, command decoders, security primitives and tamper-proofing hardware, as necessary to perform the functions described herein. User device 102 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into user device 102 that is available and supported by user device 102, such as a touch-screen, keyboard, mouse, cursor-control device, touch-screen, microphone, digital camera, video recorder or camcorder. These devices may be used to enter information and interact with the software and other devices described herein.

System 100 may include merchant device 104, which may be associated with a merchant. Merchant device 104 may be a network-enabled computer. As referred to herein, a network-enabled computer may include, but is not limited to a computer device, or communications device including, e.g., a server, a network appliance, a personal computer, a workstation, a phone, a handheld PC, a personal digital assistant, a thin client, a fat client, an Internet browser, or other device. Merchant device 104 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

Merchant device 104 can include a processor and a memory, and it is understood that the processor may contain additional components, including processors, memories, error and parity/CRC checkers, data encoders, anticollision algorithms, controllers, command decoders, security primitives and tamper proofing hardware, as necessary to perform the functions described herein. Merchant device 104 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into merchant device 104 that is available and supported by merchant device 104, such as a touch-screen, keyboard, mouse, cursor-control device, touch-screen, microphone, digital camera, video recorder or camcorder. These devices may be used to enter information and interact with the software and other devices described herein.

In some examples, merchant device 104 may execute one or more applications, such as software applications, that enable, for example, network communications with one or more components of system 100 and transmit and/or receive data.

Merchant device 104 may be in communication with one or more servers/devices such as first data store 108, token creation device 110, and/or user device 102 via one or more network(s) 106, and may operate as a respective front-end to back-end pair with any of those servers/devices. Merchant device 104 may transmit, for example from a software application (e.g., a browser) executing on merchant device 104, one or more requests to first data store 108. The one or more requests may be associated with retrieving data from or storing data to first data store 108. First data store 108 may receive the one or more requests from merchant device 104. Based on the one or more requests from merchant device 104, first data store 108 may be configured to retrieve the requested data or store the requested data. First data store 108 may be configured to transmit the retrieved data to merchant device 104, the retrieved data being responsive to the one or more requests. This may include loading transaction history, user behavior pattern data, user shopping account information, user name, user email, user phone number, user password, user login name, and fraud-related data from first data store 108.

In some embodiments, merchant device 104 can include a service that allows businesses to accept, process, and manage payments from users. It acts as an intermediary between a merchant and their bank or processor to securely transfer funds from the user's payment instrument to the merchant. Merchant device 104 can be used for in-person, online, or in-app payments, and can accept various payment methods/instruments, including credit cards, debit cards, and digital wallets. Merchant device 104 can also use encryption tools and safety protocols to ensure secure transactions, such as Transport Layer Security (TLS) or Secure Sockets Layer (SSL) certificates, Payment Card Industry Data Security Standard (PCI DSS) compliance, and fraud prevention tools like Address Verification Service (AVS) and/or Card Verification Value (CVV).

System 100 may include one or more networks 106. In some examples, network 106 may be one or more of a wireless network, a wired network or any combination of wireless network and wired network and may be configured to connect merchant device 104 to user device 102, token creation device 110, first payment facilitator device 114, and second payment facilitator device 118. For example, network 106 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11 family of networking, Bluetooth, NFC, Radio Frequency Identification (RFID), Wi-Fi, and/or the like.

In addition, network 106 may include, without limitation, telephone lines, fiber optics, IEEE Ethernet 802.3, a wide area network, a wireless personal area network, a LAN, or a global network such as the Internet. In addition, network 106 may support an Internet network, a wireless communication network, a cellular network, or the like, or any combination thereof. network 106 may further include one network, or any number of the exemplary types of networks mentioned above, operating as a stand-alone network or in cooperation with each other. network 106 may utilize one or more protocols of one or more network elements to which they are communicatively coupled. Network 106 may translate to or from other protocols to one or more protocols of network devices. Although network 106 is depicted as a single network, it should be appreciated that according to one or more examples, network 106 may comprise a plurality of interconnected networks, such as, for example, the Internet, a service provider's network, a cable television network, corporate networks, such as credit card association networks, and home networks.

System 100 may include one or more first data store 108. First data store 108 can store user's transaction history, personal identifying information of users, user's purchase behavior patterns, fraud data, login credentials, and so on. First data store 108 can be a database. The database may comprise a relational database, a non-relational database, or other database implementations, and any combination thereof, including a plurality of relational databases and non-relational databases. In some examples, first data store 108 may comprise a desktop database, a mobile database, or an in-memory database. Further, first data store 108 may be hosted internally by merchant device 104, or first data store 108 may be hosted externally to any component of system 100, such as by a cloud-based platform, or in any storage device that is in data communication with merchant device 104. In some examples, first data store 108 may be in data communication with any number of components of system 100.

System 100 may include token creation device 110. Token creation device 110 may include a memory and one or more processors, which are coupled to the memory. Token creation device 110 may be configured to receive token creation requests from merchant device 104. Token creation device 110 may be configured to receive user identifying information from merchant device 104. Token creation device 110 may be configured to transmit payment tokens, payment instruments of the user, and/or payment token ranking to merchant device 104. Token creation device 110 may be configured to communicate with first payment facilitator device 114 and second payment facilitator device 118 for requesting information/credentials of payment instruments of the user. Token creation device 110 may be a server controlled by a financial institution.

In some examples, token creation device 110 may execute one or more applications, such as software applications, that enable, for example, network communications with one or more components of system 100, transmit and/or receive data, and perform the functions described herein.

Second data store 112 can be a database hosted on token creation device 110. The database may comprise a relational database, a non-relational database, or other database implementations, and any combination thereof, including a plurality of relational databases and non-relational databases. In some examples, second data store 112 may comprise a desktop database, a mobile database, or an in-memory database. Further, second data store 112 may be hosted internally by token creation device 110, or second data store 112 may be hosted externally to any component of system 100, such as by a cloud-based platform, or in any storage device that is in data communication with token creation device 110. In some examples, second data store 112 may be in data communication with any number of components of system 100. Second data store 112 can operate to store payment tokens, credentials and information of payment instruments, payment token ranking, associations between payment tokens and credentials and information of payment instruments, and so on. In some embodiments, second data store 112 can receive and decrypt encrypted data from merchant device 104 to act as a validation system of the identity of the user of user device 102. Second data store 112 can therefore provide a factor of authentication for the system described herein. Second data store 112 can store user's bank account information such as real card number, virtual card number, expiration date, card verification value (CVV), mailing and billing addresses of the user, transaction data history, account balance, available fund, and so forth. Token creation device 110 can communicate such information to merchant device 104 to allow merchant device 104 to authorize or deny transactions of the user.

System 100 may include first payment facilitator device 114, which may be associated with a first payment facilitator. The first payment facilitator may be a bank, a credit issuer, or a payment processor. First payment facilitator device 114 may be a network-enabled computer. As referred to herein, a network-enabled computer may include, but is not limited to a computer device, or communications device including, e.g., a server, a network appliance, a personal computer, a workstation, a phone, a handheld PC, a personal digital assistant, a thin client, a fat client, an Internet browser, or other device. First payment facilitator device 114 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

First payment facilitator device 114 can include a processor and a memory, and it is understood that the processor may contain additional components, including processors, memories, error and parity/CRC checkers, data encoders, anticollision algorithms, controllers, command decoders, security primitives and tamper proofing hardware, as necessary to perform the functions described herein. Payment facilitator device 114 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into first payment facilitator device 114 that is available and supported by first payment facilitator device 114, such as a touch-screen, keyboard, mouse, cursor-control device, touch-screen, microphone, digital camera, video recorder or camcorder. These devices may be used to enter information and interact with the software and other devices described herein.

In some examples, first payment facilitator device 114 may execute one or more applications, such as software applications, that enable, for example, network communications with one or more components of system 100, transmit and/or receive data, and perform the functions described herein.

First payment facilitator device 114 may be in communication with one or more servers/devices such as third data store 116, token creation device 110, and/or user device 102 via one or more network(s) 106, and may operate as a respective front-end to back-end pair with any of those servers/devices. First payment facilitator device 114 may transmit, for example from a software application (e.g., a browser) executing on first payment facilitator device 114, one or more requests to third data store 116. The one or more requests may be associated with retrieving data from or storing data to third data store 116. Third data store 116 may receive the one or more requests from first payment facilitator device 114. Based on the one or more requests from first payment facilitator device 114, third data store 116 may be configured to retrieve the requested data or store the requested data. Third data store 116 may be configured to transmit the retrieved data to first payment facilitator device 114, the retrieved data being responsive to the one or more requests. This may include loading transaction history, user behavior pattern data, user shopping account information, user name, user email, user phone number, user password, user login name, payment instrument credentials and information, and fraud-related data from third data store 116.

In some embodiments, first payment facilitator device 114 can include a service that allows businesses to accept, process, and manage payments from users. It acts as an intermediary between a merchant and their bank or processor to securely transfer funds from the user's payment instrument to the merchant. First payment facilitator device 114 can be used for in-person, online, or in-app payments, and can accept various payment methods/instruments, including credit cards, debit cards, and digital wallets. First payment facilitator device 114 can also use encryption tools and safety protocols to ensure secure transactions, such as Transport Layer Security (TLS) or Secure Sockets Layer (SSL) certificates, Payment Card Industry Data Security Standard (PCI DSS) compliance, and fraud prevention tools like Address Verification Service (AVS) and/or Card Verification Value (CVV).

First payment facilitator device 114 may be configured to receive requests from token creation device 110 for transmitting credentials and information of payment instruments of a user. First payment facilitator device 114 may be configured to determine whether to transmit credentials and information of payment instruments of the user to token creation device 110, and what step-up authentication methods are required for payment instruments of the user.

Third data store 116 can be a database hosted on first payment facilitator device 114. The database may comprise a relational database, a non-relational database, or other database implementations, and any combination thereof, including a plurality of relational databases and non-relational databases. In some examples, third data store 116 may comprise a desktop database, a mobile database, or an in-memory database. Further, third data store 116 may be hosted internally by first payment facilitator device 114, or third data store 116 may be hosted externally to any component of system 100, such as by a cloud-based platform, or in any storage device that is in data communication with first payment facilitator device 114. In some examples, third data store 116 may be in data communication with any number of components of system 100. Third data store 116 can operate to store credentials and information of payment instruments, and requirements for step-up methods for payment instruments. In some embodiments, third data store 116 can receive and decrypt encrypted data from merchant device 104 to act as a validation system of the identity of the user of user device 102. Third data store 116 can therefore provide a factor of authentication for the system described herein. Third data store 116 can store user's bank account information such as real card number, virtual card number, expiration date, card verification value (CVV), mailing and billing addresses of the user, transaction data history, account balance, available fund, and so forth. First payment facilitator device 114 can communicate such information to merchant device 104 to allow merchant device 104 to authorize or deny transactions of the user.

System 100 may include second payment facilitator device 118, which may be associated with a second payment facilitator. The second payment facilitator may be a bank, a credit issuer, or a payment processor. Second payment facilitator device 118 may be a network-enabled computer. As referred to herein, a network-enabled computer may include, but is not limited to a computer device, or communications device including, e.g., a server, a network appliance, a personal computer, a workstation, a phone, a handheld PC, a personal digital assistant, a thin client, a fat client, an Internet browser, or other device. Second payment facilitator device 118 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

Second payment facilitator device 118 can include a processor and a memory, and it is understood that the processor may contain additional components, including processors, memories, error and parity/CRC checkers, data encoders, anticollision algorithms, controllers, command decoders, security primitives and tamper proofing hardware, as necessary to perform the functions described herein. Second payment facilitator device 118 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into second payment facilitator device 118 that is available and supported by second payment facilitator device 118, such as a touch-screen, keyboard, mouse, cursor-control device, touch-screen, microphone, digital camera, video recorder or camcorder. These devices may be used to enter information and interact with the software and other devices described herein.

In some examples, second payment facilitator device 118 may execute one or more applications, such as software applications, that enable, for example, network communications with one or more components of system 100, transmit and/or receive data, and perform the functions described herein.

Second payment facilitator device 118 may be in communication with one or more servers/devices such as fourth data store 120, token creation device 110, merchant device 104 and/or user device 102 via one or more network(s) 106, and may operate as a respective front-end to back-end pair with any of those servers/devices. Second payment facilitator device 118 may transmit, for example from a software application (e.g., a browser) executing on second payment facilitator device 118, one or more requests to fourth data store 120. The one or more requests may be associated with retrieving data from or storing data to fourth data store 120. Fourth data store 120 may receive the one or more requests from second payment facilitator device 118. Based on the one or more requests from second payment facilitator device 118, fourth data store 120 may be configured to retrieve the requested data or store the requested data. Fourth data store 120 may be configured to transmit the retrieved data to second payment facilitator device 118, the retrieved data being responsive to the one or more requests. This may include loading transaction history, user behavior pattern data, user shopping account information, user name, user email, user phone number, user password, user login name, payment instrument credentials and information, and fraud-related data from fourth data store 120.

In some embodiments, second payment facilitator device 118 can include a service that allows businesses to accept, process, and manage payments from users. It acts as an intermediary between a merchant and their bank or processor to securely transfer funds from the user's payment instrument to the merchant. Second payment facilitator device 118 can be used for in-person, online, or in-app payments, and can accept various payment methods/instruments, including credit cards, debit cards, and digital wallets. Second payment facilitator device 118 can also use encryption tools and safety protocols to ensure secure transactions, such as Transport Layer Security (TLS) or Secure Sockets Layer (SSL) certificates, Payment Card Industry Data Security Standard (PCI DSS) compliance, and fraud prevention tools like Address Verification Service (AVS) and/or Card Verification Value (CVV).

Second payment facilitator device 118 may be configured to receive requests from token creation device 110 for transmitting credentials and information of payment instruments of a user. Second payment facilitator device 118 may be configured to determine whether to transmit credentials and information of payment instruments of the user to token creation device 110, and what step-up authentication methods are required for payment instruments of the user.

Fourth data store 120 can be a database hosted on second payment facilitator device 118. The database may comprise a relational database, a non-relational database, or other database implementations, and any combination thereof, including a plurality of relational databases and non-relational databases. In some examples, fourth data store 120 may comprise a desktop database, a mobile database, or an in-memory database. Further, fourth data store 120 may be hosted internally by second payment facilitator device 118, or fourth data store 120 may be hosted externally to any component of system 100, such as by a cloud-based platform, or in any storage device that is in data communication with second payment facilitator device 118. In some examples, fourth data store 120 may be in data communication with any number of components of system 100. Fourth data store 120 can operate to store credentials and information of payment instruments, and requirements for step-up methods for payment instruments. In some embodiments, fourth data store 120 can receive and decrypt encrypted data from merchant device 104 to act as a validation system of the identity of the user of user device 102. Fourth data store 120 can therefore provide a factor of authentication for the system described herein. Fourth data store 120 can store user's bank account information such as real card number, virtual card number, expiration date, card verification value (CVV), mailing and billing addresses of the user, transaction data history, account balance, available fund, and so forth. Second payment facilitator device 118 can communicate such information to merchant device 104 to allow merchant device 104 to authorize or deny transactions of the user.

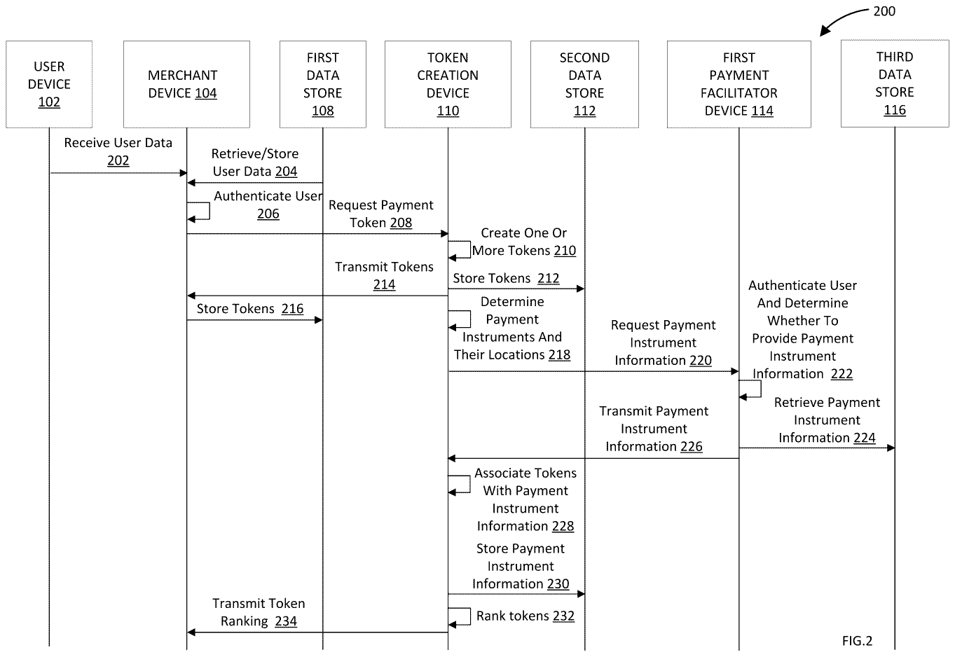

FIG. 2 is a sequence flow 200 diagram illustrating a possible sequence of events for generating and using payment tokens according to some embodiments. This sequence flow 200 provides one example of how the payment tokens are generated and used for streamlining transaction payment.

As shown at 202, a user may sign up for or sign into an account with a merchant. The user may use user device 102 to sign up for or sign into the account deployed on merchant device 104 associated with the merchant. The user may enter user data into the account, such as the user's name, the user's phone number, the user's email address, the user's home address, the user's shipping address, the user's billing address, and so forth. The user data can be received by merchant device 104 from user device 102.

At 204, if the user is signing into the account using the user's credentials, merchant device 104 may retrieve user data associated with the user from first data store 108, at least, based on the received user credentials. If the user is signing up for the account, merchant device 104 may store onto first data store 108 the user data received from user device 102. As described above, the user data can include user name, phone number, shipping address, home address, billing address, email address, date and time of an merchant account created with the merchant, login credentials of the user for the merchant account, and so forth.

At 206, merchant device 104 may authenticate the user based on the retrieved user data and/or received user data. For example, the user can be authenticated based on the login credentials of the user for the merchant account. The user can also be authenticated based on the billing address and/or phone number of the user.

At 208, merchant device 104 may transmit to token creation device 110 a request for generating payment tokens associated with the user. The payment tokens may include one or more payment tokens because the user may be associated with multiple payment instruments (e.g., credit cards, debit cards, bank account, digital wallets). The request may include the user data received from user device 102 or retrieved from first data store 108. The request may also include merchant specific data associated with merchant. The merchant specific data can include at least one selected from the group of personal identification information of the user, past transactions of the user conducted with the merchant, and additional card data of the card such as account balance, available fund, virtual card numbers, an identifier of the merchant, a business type of the merchant, and so on.

At 210, upon receiving the request, token creation device 110 may create one or more payment tokens for the user based on the received user data included in the request. Token creation device 110 may further authenticate the user and/or the merchant based on the received user data and/or the merchant specific data. At 212, token creation device 110 may store the one or more payment tokens into second data store 112. Token creation device 110 may also store the received user data and/or the merchant specific data into second data store 112.

At 214, after generating the payment tokens, token creation device 110 may transmit the payment tokens to merchant device 104. Merchant device 104 receives the payment tokens and at 216 may store the payment tokens in first data store 108. At this moment, the payment tokens may be blank tokens. That is, the tokens have not yet been associated with any payment instruments of the user. With the payment tokens created in advance (e.g., prior to purchase moment), the user can check out quickly in the checkout workflow. When the user goes to check out, the user can also have an option to go through step-ups and then pay with those tokens. This can prevent from having the user waiting while checking out and can also prevent additional load time. This can streamline and make the checkout experience online more efficient with network tokens.

At 218, token creation device 110 may determine whether the user has one or more payment instruments. For example, token creation device 110 may obtain credit report, credit history, transaction history of the user and determine whether the user has one or more payment instruments. Token creation device 110 may determine whether the user has one or more payment instruments based on the user data and/or the merchant specific data received from merchant device 104. Token creation device 110 may then determine the locations of the payment instruments. For example, which banks or payment facilitators issue or hold the payment instruments. Token creation device 110 may determine the payment instruments and their locations using one or more machine learning (ML) models which will be described below.

Upon determine the payment instruments and their locations (e.g., first payment facilitator device 114), at 220, token creation device 110 may transmit a request to first payment facilitator device 114 for obtaining payment instrument information of one or more payment instruments held by first payment facilitator device 114. For example, the user may have one or more accounts or credit cards with first payment facilitator associated with first payment facilitator device 114.

At 222, after receiving the request from token creation device 110, first payment facilitator device 114 may authenticate the user. The request may include the user data received from user device 102 or retrieved from first data store 108. The request may also include merchant specific data associated with merchant device 104. The merchant specific data can include at least one selected from the group of personal identification information of the user, past transactions of the user conducted with the merchant, and additional card data of the card such as account balance, available fund, virtual card numbers, an identifier of the merchant, a business type of the merchant, and so on. First payment facilitator device 114 may authenticate the user based on the user data and/or the merchant specific data.

First payment facilitator device 114 may determine if the first payment facilitator wants to participate the token payment. For example, first payment facilitator device 114 may determine whether token creation device 110 is a bad actor and/or is associated with a fraudulent website, and if so, will not return payment credential. First payment facilitator device 114 may determine whether step-up authentications are required for those payment instruments. That is, before sending out the payment credentials to token creation device 110, first payment facilitator device 114 can determine if the request is a fraudulent request, based on which, then determine if returning the requested payment credentials. First payment facilitator device 114 can also determine if they require additional authentication factors in addition to tokens for authorizing transactions. First payment facilitator device 114 can also use ML models to determine if returning the requested payment credentials and if additional authentication factors are required in addition to tokens for authorizing transactions.

If first payment facilitator device 114 can confirm that the user's identity is real, at 224, first payment facilitator device 114 may retrieve payment instrument information/credentials from third data store 116. At 226, first payment facilitator device 114 transmit the payment instrument credentials back to token creation device 110.

In some embodiments, the user may have payment instruments associated with more than one payment facilitators. For example, in addition to the first payment facilitator associated with first payment facilitator device 114, the user may have additional payment instruments associated with second payment facilitator device 118. The payment credentials of the additional payment instruments may be stored in fourth data store 120. Token creation device 110 may request the payment credentials of the additional payment instruments from second payment facilitator device 118. Second payment facilitator device 118 may determine if returning the requested payment credentials and if additional authentication factors are required in addition to tokens for authorizing transactions. Details can refer to the above description with respect to first payment facilitator device 114.

At 228, after receiving the payment instrument credentials from one or more payment facilitator devices such as first payment facilitator device 114 and second payment facilitator device 118, token creation device 110 can associate the payment instrument credentials with the corresponding payment tokens. At 230, token creation device 110 can store into second data store 112 the payment instrument credentials as well as the associations between the payment instrument credentials and the corresponding payment tokens.

At 232, token creation device 110 may rank the payment tokens to generate a ranking list. The ranking list may include the payment tokens in an order of most preferable payment token to least preferable payment token. In some embodiments, token creation device 110 may apply a ML model to perform the ranking for selecting the most optimal token for use at that merchant. The ranking can be based on offers or rewards associated with a payment instrument, membership type associated with a payment instrument, transaction type associated with a payment instrument, transaction history associated with a payment instrument, issuers associated with a payment instrument, credit limit associated with a payment instrument, credit balance associated with a payment instrument. The ranking can be dynamic. For example, an order of a payment token on the ranking list can be changed based on the changing balance or credit limit of the payment instrument associated with that payment token. For example, a payment token associated with a payment instrument that is increasing credit balance can be moved toward to the least preferable payment token.

At 234, token creation device 110 may transmit token ranking to merchant device 104. Merchant device 104 may then store the token ranking in first data store 108. Token creation device 110 may also transmit the issuer's names of the payment instruments but not credentials of the payment instruments to merchant device 104, so when the user is checking out, the user can know which payment instruments associated with corresponding payment tokens while data security can be ensured because the credentials of the payment instruments are not stored with merchant device 104.

Merchant device 104 can inform the user at checkout that the payment tokens are available and what step-up authentications are required. Merchant device 104 can verify the user through the step-up authentications, and the user can select a card to check out.

In some embodiments, the token ranking can be based on the user's preference (e.g., the user prefers one card over another card), past purchase history of the user, card reward, card cash rebate.

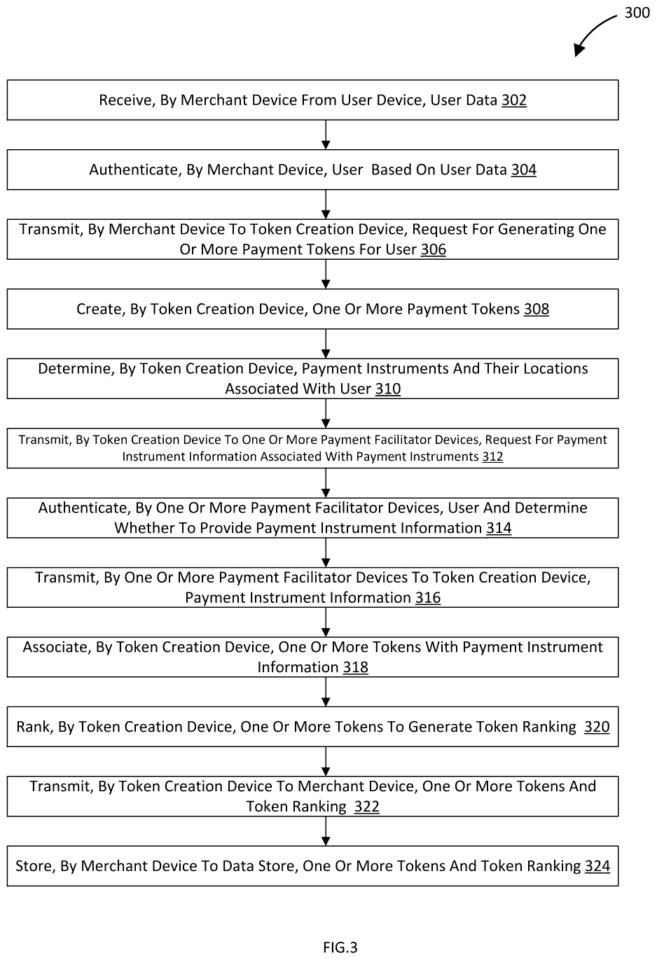

FIG. 3 is a flow chart illustrating some operations of an example method 300 for generating and using payment tokens according to one embodiment. Method 300 may be performed by system 100 as shown in FIG. 1.

At step 302, a user may sign up for or sign into an account with a merchant. The user may use user device 102 to sign up for or sign into the account deployed on merchant device 104 associated with the merchant. The user may enter user data into the account, such as the user's name, the user's phone number, the user's email address, the user's home address, the user's shipping address, the user's billing address, and so forth. Merchant device 104 receives the user data from user device 102.

At step 304, if the user is signing into the account using the user's credentials, merchant device 104 may retrieve user data associated with the user from first data store 108, at least, based on the received user credentials. If the user is signing up for the account, merchant device 104 may store onto first data store 108 the user data received from user device 102. As described above, the user data can include user name, phone number, shipping address, home address, billing address, email address, date and time of an merchant account created with the merchant, login credentials of the user for the merchant account, and so forth. Merchant device 104 may authenticate the user based on the retrieved user data and/or received user data. For example, the user can be authenticated based on the login credentials of the user for the merchant account. The user can also be authenticated based on the billing address and/or phone number of the user.

At step 306, merchant device 104 may transmit to token creation device 110 a request for generating one or more payment tokens associated with the user. The payment tokens may include one or more payment tokens because the user may be associated with multiple payment instruments (e.g., credit cards, debit cards, bank account, digital wallets). The request may include the user data received from user device 102 or retrieved from first data store 108. The request may also include merchant specific data associated with merchant. The merchant specific data can include at least one selected from the group of personal identification information of the user, past transactions of the user conducted with the merchant, and additional card data of the card such as account balance, available fund, virtual card numbers, an identifier of the merchant, a business type of the merchant, and so on.

At step 308, upon receiving the request, token creation device 110 may create one or more payment tokens for the user based on the received user data included in the request. Token creation device 110 may further authenticate the user and/or the merchant based on the received user data and/or the merchant specific data. Token creation device 110 may store the one or more payment tokens into second data store 112. Token creation device 110 may also store the received user data and/or the merchant specific data into second data store 112. After generating the payment tokens, token creation device 110 may transmit the payment tokens to merchant device 104. Merchant device 104 receives the payment tokens and may store the payment tokens in first data store 108. At this moment, the payment tokens may be blank tokens. That is, the tokens have not yet been associated with any payment instruments of the user. With the payment tokens created in advance (e.g., prior to purchase moment), the user can check out quickly in the checkout workflow. When the user goes to check out, the user can also have an option to go through step-ups and then pay with those tokens. This can prevent from having the user waiting while checking out and can also prevent additional load time. This can streamline and make the checkout experience online more efficient with network tokens.

At step 310, token creation device 110 may determine whether the user has one or more payment instruments. For example, token creation device 110 may obtain credit report, credit history, transaction history of the user and determine whether the user has one or more payment instruments. Token creation device 110 may determine whether the user has one or more payment instruments based on the user data and/or the merchant specific data received from merchant device 104. Token creation device 110 may then determine the locations of the payment instruments. For example, which banks or payment facilitators issue or hold the payment instruments. Token creation device 110 may determine the payment instruments and their locations using one or more ML models which will be described below.

Upon determining the payment instruments and their locations (e.g., first payment facilitator device 114 and second payment facilitator device 118), at step 312, token creation device 110 may transmit a request to one or more payment facilitator devices such as first payment facilitator device 114 and second payment facilitator device 118 for obtaining payment instrument information of one or more payment instruments held by one or more payment facilitator devices. For example, the user may have one or more accounts or credit cards with first payment facilitator associated with first payment facilitator device 114.

At step 314, after receiving the request from token creation device 110, the one or more payment facilitator devices may authenticate the user and determine whether to provide payment instrument information. The request may include the user data received from user device 102 or retrieved from first data store 108. The request may also include merchant specific data associated with merchant device 104. The merchant specific data can include at least one selected from the group of personal identification information of the user, past transactions of the user conducted with the merchant, and additional card data of the card such as account balance, available fund, virtual card numbers, an identifier of the merchant, a business type of the merchant, and so on. The one or more payment facilitator devices may authenticate the user based on the user data and/or the merchant specific data.

The one or more payment facilitator devices may determine if they want to participate the token payment. For example, first payment facilitator device 114 may determine whether token creation device 110 is a bad actor and/or is associated with a fraudulent website, and if so, will not return payment credential. The one or more payment facilitator devices may determine whether step-up authentications are required for those payment instruments. That is, before sending out the payment credentials to token creation device 110, the one or more payment facilitator devices can determine if the request is a fraudulent request, based on which, then determine if returning the requested payment credentials. The one or more payment facilitator devices can also determine if they require additional authentication factors in addition to tokens for authorizing transactions. The one or more payment facilitator devices can also use ML models to determine if returning the requested payment credentials and if additional authentication factors are required in addition to tokens for authorizing transactions.

If the one or more payment facilitator devices can confirm that the user's identity is real, at step 316, the one or more payment facilitator devices may retrieve payment instrument information/credentials from their respective data store, such as third data store 116 and fourth data store 120. The one or more payment facilitator devices transmit the payment instrument credentials back to token creation device 110.

In some embodiments, the user may have payment instruments associated with more than one payment facilitators. For example, in addition to the first payment facilitator associated with first payment facilitator device 114, the user may have additional payment instruments associated with second payment facilitator device 118. The payment credentials of the additional payment instruments may be stored in fourth data store 120. Token creation device 110 may request the payment credentials of the additional payment instruments from second payment facilitator device 118. Second payment facilitator device 118 may determine if returning the requested payment credentials and if additional authentication factors are required in addition to tokens for authorizing transactions.

At step 318, after receiving the payment instrument credentials from one or more payment facilitator devices such as first payment facilitator device 114 and second payment facilitator device 118, token creation device 110 can associate the payment instrument credentials with the corresponding payment tokens. Token creation device 110 can store into second data store 112 the payment instrument credentials as well as the associations between the payment instrument credentials and the corresponding payment tokens.

At step 320, token creation device 110 may rank the payment tokens to generate a ranking list. The ranking list may include the payment tokens in an order of most preferable payment token to least preferable payment token. In some embodiments, token creation device 110 may apply a ML model to perform the ranking for selecting the most optimal token for use at that merchant. The ranking can be based on offers or rewards associated with a payment instrument, membership type associated with a payment instrument, transaction type associated with a payment instrument, transaction history associated with a payment instrument, issuers associated with a payment instrument, credit limit associated with a payment instrument, credit balance associated with a payment instrument. The ranking can be dynamic. For example, an order of a payment token on the ranking list can be changed based on the changing balance or credit limit of the payment instrument associated with that payment token. For example, a payment token associated with a payment instrument that is increasing credit balance can be moved toward to the least preferable payment token.

At step 322, token creation device 110 may transmit one or more tokens and token ranking to merchant device 104. At step 324, merchant device 104 may then store the one or more tokens and the token ranking in first data store 108. Token creation device 110 may also transmit the issuer's names of the payment instruments but not credentials of the payment instruments to merchant device 104, so when the user is checking out, the user can know which payment instruments associated with corresponding payment tokens while data security can be ensured because the credentials of the payment instruments are not stored with merchant device 104.

Merchant device 104 can inform the user at checkout that the payment tokens are available and what step-up authentications are required. Merchant device 104 can verify the user through the step-up authentications, and the user can select a card to check out.

In some embodiments, the token ranking can be based on the user's preference (e.g., the user prefers one card over another card), past purchase history of the user, card reward, card cash rebate.

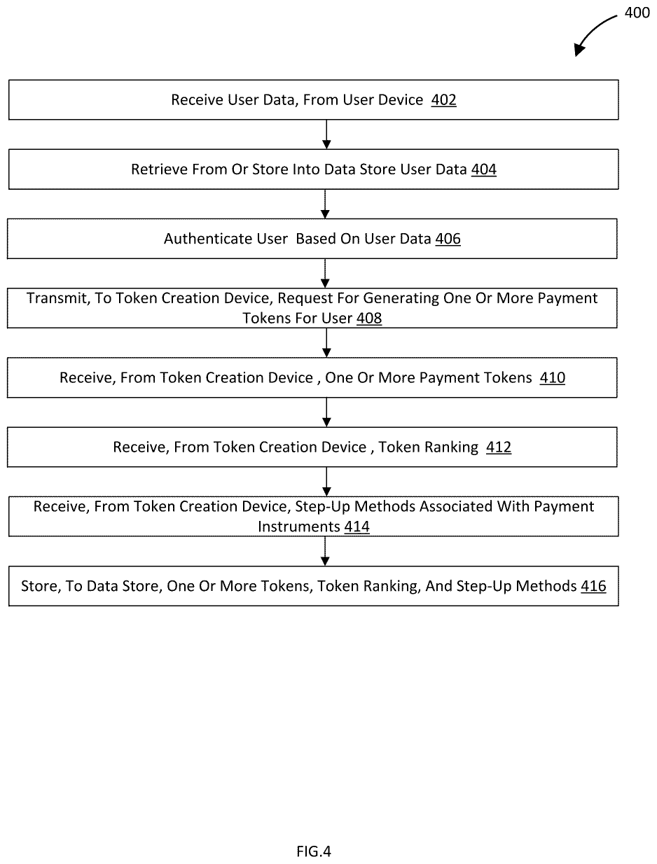

FIG. 4 is a flow chart illustrating some operations of an example method 400 for generating and using payment tokens according to one embodiment. Method 300 may be performed by merchant device 104 as shown in FIG. 1.

At step 402, a user may sign up for or sign into an account with a merchant. The user may use user device 102 to sign up for or sign into the account deployed on merchant device 104 associated with the merchant. The user may enter user data into the account, such as the user's name, the user's phone number, the user's email address, the user's home address, the user's shipping address, the user's billing address, and so forth. Merchant device 104 receives the user data from user device 102.

At step 402, if the user is signing into the account using the user's credentials, merchant device 104 may retrieve user data associated with the user from first data store 108, at least, based on the received user credentials. If the user is signing up for the account, merchant device 104 may store onto first data store 108 the user data received from user device 102. As described above, the user data can include user name, phone number, shipping address, home address, billing address, email address, date and time of an merchant account created with the merchant, login credentials of the user for the merchant account, and so forth.

At step 406, merchant device 104 may authenticate the user based on the retrieved user data and/or received user data. For example, the user can be authenticated based on the login credentials of the user for the merchant account. The user can also be authenticated based on the billing address and/or phone number of the user.

At step 408, merchant device 104 may transmit to token creation device 110 a request for generating one or more payment tokens associated with the user. The payment tokens may include one or more payment tokens because the user may be associated with multiple payment instruments (e.g., credit cards, debit cards, bank account, digital wallets). The request may include the user data received from user device 102 or retrieved from first data store 108. The request may also include merchant specific data associated with merchant. The merchant specific data can include at least one selected from the group of personal identification information of the user, past transactions of the user conducted with the merchant, and additional card data of the card such as account balance, available fund, virtual card numbers, an identifier of the merchant, a business type of the merchant, and so on.

After generating the payment tokens, token creation device 110 may transmit the payment tokens to merchant device 104. At step 410, merchant device 104 receives the payment tokens and may store the payment tokens in first data store 108. At this moment, the payment tokens may be blank tokens. That is, the tokens have not yet been associated with any payment instruments of the user. With the payment tokens created in advance (e.g., prior to purchase moment), the user can check out quickly in the checkout workflow. When the user goes to check out, the user can also have an option to go through step-ups and then pay with those tokens. This can prevent from having the user waiting while checking out and can also prevent additional load time. This can streamline and make the checkout experience online more efficient with network tokens.

Token creation device 110 may transmit a request to one or more payment facilitator devices such as first payment facilitator device 114 and second payment facilitator device 118 for obtaining payment instrument information of one or more payment instruments held by one or more payment facilitator devices. After receiving the payment instrument credentials from one or more payment facilitator devices such as first payment facilitator device 114 and second payment facilitator device 118, token creation device 110 can associate the payment instrument credentials with the corresponding payment tokens. Token creation device 110 may rank the payment tokens to generate a ranking list. The ranking list may include the payment tokens in an order of most preferable payment token to least preferable payment token. In some embodiments, token creation device 110 may apply a ML model to perform the ranking for selecting the most optimal token for use at that merchant. The ranking can be based on offers or rewards associated with a payment instrument, membership type associated with a payment instrument, transaction type associated with a payment instrument, transaction history associated with a payment instrument, issuers associated with a payment instrument, credit limit associated with a payment instrument, credit balance associated with a payment instrument. The ranking can be dynamic. For example, an order of a payment token on the ranking list can be changed based on the changing balance or credit limit of the payment instrument associated with that payment token. For example, a payment token associated with a payment instrument that is increasing credit balance can be moved toward to the least preferable payment token. At step 412, merchant device 104 may receive the token ranking from token creation device 110.

At step 414, merchant device 104 may receive from token creation device 110 step-up authentication methods associated with the one or more payment instruments. Merchant device 104 may also receive from token creation device 110 the issuer's names of the payment instruments but not credentials of the payment instruments, so when the user is checking out, the user can know which payment instruments associated with corresponding payment tokens while data security can be ensured because the credentials of the payment instruments are not stored with merchant device 104.

At step 416, merchant device may store in first data store 108 the one or more tokens, the token ranking, and the step-up authentication methods.

Merchant device 104 can inform the user at checkout that the payment tokens are available and what step-up authentications are required. Merchant device 104 can verify the user through the step-up authentications, and the user can select a card to check out.

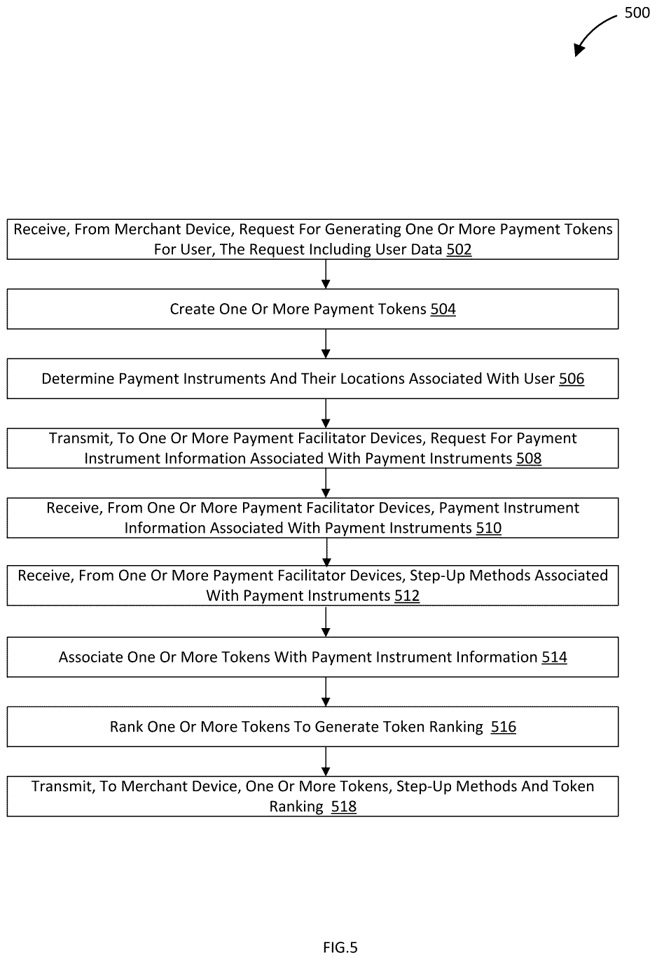

FIG. 5 is a flow chart illustrating some operations of an example method 500 for generating and using payment tokens according to one embodiment. Method 500 may be performed by token creation device 110 as shown in FIG. 1.

At step 502, token creation device 110 may receive, from merchant device 104, a request for generating one or more payment tokens for a user. The request can include user data. A user may sign up for or sign into an account with a merchant. The user may use user device 102 to sign up for or sign into the account deployed on merchant device 104 associated with the merchant. The user may enter user data into the account, such as the user's name, the user's phone number, the user's email address, the user's home address, the user's shipping address, the user's billing address, and so forth. Merchant device 104 receives the user data from user device 102. If the user is signing into the account using the user's credentials, merchant device 104 may retrieve user data associated with the user from first data store 108, at least, based on the received user credentials. If the user is signing up for the account, merchant device 104 may store onto first data store 108 the user data received from user device 102. As described above, the user data can include user name, phone number, shipping address, home address, billing address, email address, date and time of an merchant account created with the merchant, login credentials of the user for the merchant account, and so forth. Merchant device 104 may authenticate the user based on the retrieved user data and/or received user data. For example, the user can be authenticated based on the login credentials of the user for the merchant account. The user can also be authenticated based on the billing address and/or phone number of the user. Merchant device 104 may then transmit to token creation device 110 a request for generating one or more payment tokens associated with the user. The payment tokens may include one or more payment tokens because the user may be associated with multiple payment instruments (e.g., credit cards, debit cards, bank account, digital wallets). The request may include the user data received from user device 102 or retrieved from first data store 108. The request may also include merchant specific data associated with merchant. The merchant specific data can include at least one selected from the group of personal identification information of the user, past transactions of the user conducted with the merchant, and additional card data of the card such as account balance, available fund, virtual card numbers, an identifier of the merchant, a business type of the merchant, and so on.

At step 504, upon receiving the request, token creation device 110 may create one or more payment tokens for the user based on the received user data included in the request. Token creation device 110 may further authenticate the user and/or the merchant based on the received user data and/or the merchant specific data. Token creation device 110 may store the one or more payment tokens into second data store 112. Token creation device 110 may also store the received user data and/or the merchant specific data into second data store 112. At this moment, the payment tokens may be blank tokens. That is, the tokens have not yet been associated with any payment instruments of the user. With the payment tokens created in advance (e.g., prior to purchase moment), the user can check out quickly in the checkout workflow. When the user goes to check out, the user can also have an option to go through step-ups and then pay with those tokens. This can prevent from having the user waiting while checking out and can also prevent additional load time. This can streamline and make the checkout experience online more efficient with network tokens.

At step 506, token creation device 110 may determine whether the user has one or more payment instruments. For example, token creation device 110 may obtain credit report, credit history, transaction history of the user and determine whether the user has one or more payment instruments. Token creation device 110 may determine whether the user has one or more payment instruments based on the user data and/or the merchant specific data received from merchant device 104. Token creation device 110 may then determine the locations of the payment instruments. For example, which banks or payment facilitators issue or hold the payment instruments. Token creation device 110 may determine the payment instruments and their locations using one or more ML models which will be described below.

Upon determining the payment instruments and their locations (e.g., first payment facilitator device 114 and second payment facilitator device 118), at step 508, token creation device 110 may transmit a request to one or more payment facilitator devices such as first payment facilitator device 114 and second payment facilitator device 118 for obtaining payment instrument information of one or more payment instruments held by one or more payment facilitator devices. For example, the user may have one or more accounts or credit cards with first payment facilitator associated with first payment facilitator device 114.

At step 510, token creation device 110 may receive the payment instrument credentials from one or more payment facilitator devices such as first payment facilitator device 114 and second payment. After receiving the request from token creation device 110, the one or more payment facilitator devices may authenticate the user and determine whether to provide payment instrument information. The request may include the user data received from user device 102 or retrieved from first data store 108. The request may also include merchant specific data associated with merchant device 104. The merchant specific data can include at least one selected from the group of personal identification information of the user, past transactions of the user conducted with the merchant, and additional card data of the card such as account balance, available fund, virtual card numbers, an identifier of the merchant, a business type of the merchant, and so on. The one or more payment facilitator devices may authenticate the user based on the user data and/or the merchant specific data. The one or more payment facilitator devices may determine if they want to participate the token payment. For example, first payment facilitator device 114 may determine whether token creation device 110 is a bad actor and/or is associated with a fraudulent website, and if so, will not return payment credential. That is, before sending out the payment credentials to token creation device 110, the one or more payment facilitator devices can determine if the request is a fraudulent request, based on which, then determine if returning the requested payment credentials. If the one or more payment facilitator devices can confirm that the user's identity is real, the one or more payment facilitator devices may retrieve payment instrument information/credentials from their respective data store, such as third data store 116 and fourth data store 120. The one or more payment facilitator devices transmit the payment instrument credentials back to token creation device 110.

At step 512, token creation device 110 may receive, from the one or more payment facilitator devices, step-up methods associated with a payment instruments. The one or more payment facilitator devices may determine whether step-up authentications are required for those payment instruments. That is, the one or more payment facilitator devices can also determine if they require additional authentication factors in addition to tokens for authorizing transactions. The one or more payment facilitator devices may transmit the step-up authentication methods to token creation device 110. In some embodiments, the one or more payment facilitator devices can also use ML models to determine if returning the requested payment credentials and if additional authentication factors are required in addition to tokens for authorizing transactions.

At step 514, after receiving the payment instrument credentials from one or more payment facilitator devices such as first payment facilitator device 114 and second payment facilitator device 118, token creation device 110 can associate the payment instrument credentials with the corresponding payment tokens.

At 516, token creation device 110 may rank the payment tokens to generate a ranking list. The ranking list may include the payment tokens in an order of most preferable payment token to least preferable payment token. In some embodiments, token creation device 110 may apply a ML model to perform the ranking for selecting the most optimal token for use at that merchant. The ranking can be based on offers or rewards associated with a payment instrument, membership type associated with a payment instrument, transaction type associated with a payment instrument, transaction history associated with a payment instrument, issuers associated with a payment instrument, credit limit associated with a payment instrument, credit balance associated with a payment instrument. The ranking can be dynamic. For example, an order of a payment token on the ranking list can be changed based on the changing balance or credit limit of the payment instrument associated with that payment token. For example, a payment token associated with a payment instrument that is increasing credit balance can be moved toward to the least preferable payment token.

At step 518, token creation device 110 may transmit one or more tokens, step-up methods, and token ranking to merchant device 104. Token creation device 110 may also transmit the issuer's names of the payment instruments but not credentials of the payment instruments to merchant device 104, so when the user is checking out, the user can know which payment instruments associated with corresponding payment tokens while data security can be ensured because the credentials of the payment instruments are not stored with merchant device 104.

Token creation device 110 can store into second data store 112, the one or more tokens, step-up methods, the token ranking, the payment instrument credentials as well as the associations between the payment instrument credentials and the corresponding payment tokens.

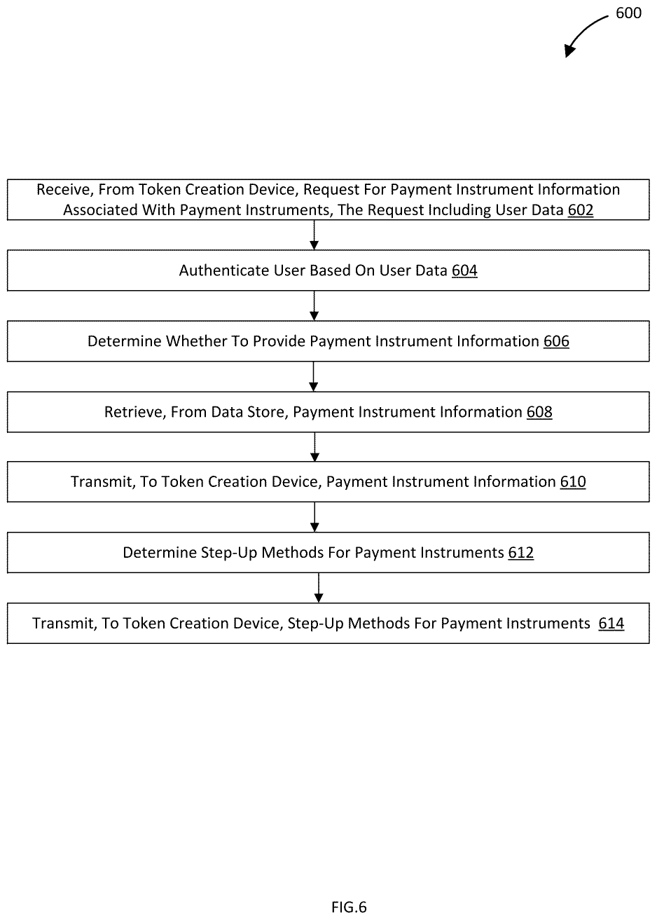

FIG. 6 is a flow chart illustrating some operations of an example method 600 for generating and using payment tokens according to one embodiment. Method 600 may be performed by first payment facilitator device 114 and/or second payment facilitator device 118 as shown in FIG. 1. In this exemplary method 600, first payment facilitator device 114 is used as an example.

At step 602, first payment facilitator device 114 may receive, from token creation device 110, a request for payment instrument information associated with a payment instruments. The request may include user data. The user data may include user name, phone number, shipping address, home address, billing address, email address, date and time of an merchant account created with the merchant, login credentials of the user for the merchant account, and so forth. The request may also include merchant specific data associated with merchant. The merchant specific data can include at least one selected from the group of personal identification information of the user, past transactions of the user conducted with the merchant, and additional card data of the card such as account balance, available fund, virtual card numbers, an identifier of the merchant, a business type of the merchant, and so on.

At step 604, after receiving the request from token creation device 110, first payment facilitator device 114 may authenticate the user based on the user data and/or the merchant specific data.

At step 606, first payment facilitator device 114 may determine whether to provide payment instrument information. First payment facilitator device 114 may determine if they want to participate in the token payment. For example, first payment facilitator device 114 may determine whether token creation device 110 is a bad actor and/or is associated with a fraudulent website, and if so, will not return payment credential.

If first payment facilitator device 114 can confirm that the user's identity is real, at step 608, first payment facilitator device 114 may retrieve payment instrument information/credentials from third data store 116. At step 610, first payment facilitator device 114 may transmit the payment instrument credentials back to token creation device 110.

At step 612, first payment facilitator device 114 may determine whether step-up authentication methods are required for those payment instruments. That is, first payment facilitator device 114 can also determine if they require additional authentication factors in addition to tokens for authorizing transactions. First payment facilitator device 114 can also use ML models to determine if returning the requested payment credentials and if additional authentication factors are required in addition to tokens for authorizing transactions.

At step 614, first payment facilitator device 114 may transmit the step-up authentication methods to token creation device 110.

In some embodiments, the user may have payment instruments associated with more than one payment facilitators. For example, in addition to the first payment facilitator associated with first payment facilitator device 114, the user may have additional payment instruments associated with second payment facilitator device 118. The payment credentials of the additional payment instruments may be stored in fourth data store 120. Token creation device 110 may request the payment credentials of the additional payment instruments from second payment facilitator device 118. Second payment facilitator device 118 may determine if returning the requested payment credentials and if additional authentication factors are required in addition to tokens for authorizing transactions.

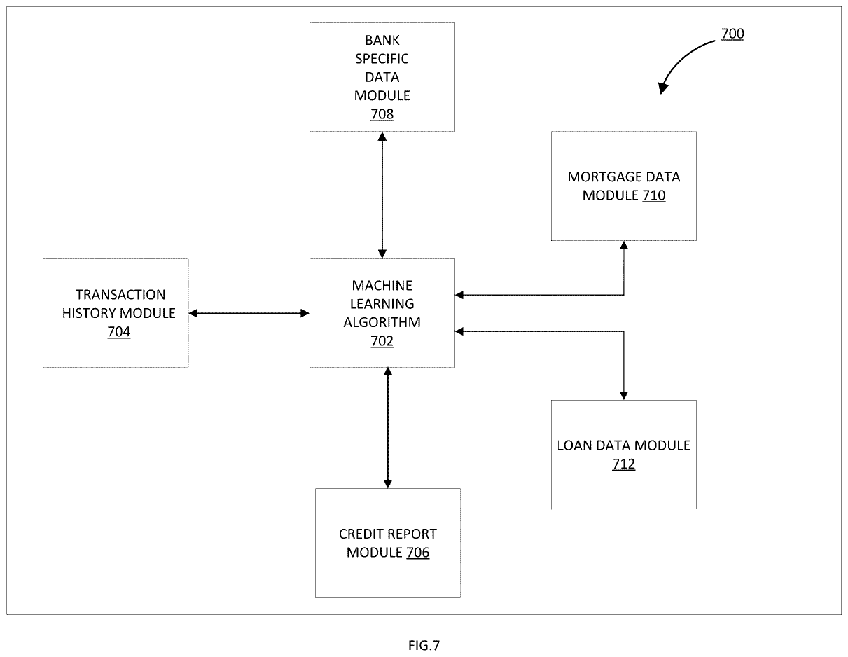

FIG. 7 illustrates a block diagram of an example machine learning model system 700 for determining payment instruments and their location configured to operate in accordance with embodiments discussed herein. Machine learning model system 700 may include machine learning algorithm 702. Machine learning algorithm 702 may include a communication interface as well as an algorithm processor coupled to a plurality of modules including transaction history module 704, credit report module 706, bank specific module 708, mortgage data module 710, and loan data module 712. The machine learning model system 700 may be performed by token creation device 110.

Transaction history module 704 can receive data of past transactions of the user. The data of past transactions can include, but are not limited to, locations of past transactions, dates of past transactions, times of past transactions, billing addresses of past transactions, shipping addresses of past transactions, amounts of past transactions, frequency of past transactions, cards used for past transactions, products or services included in past transactions, and returns or refunds of past transactions, a card number of a card used for past transactions, a card expiration date of the card used for past transactions, a cardholder name of the card used for past transactions, a card verification value (CVV) of the card used for past transactions.

Credit report module 706 can receive data about the credit report of the user. The credit report data may include, opened accounts, closed accounts, account balances, credit scores.

Bank specific data module 708 can obtain data specific to banks the user is associated with. The specific data of bank may include a location of the bank, a type of the bank, an industry in which the bank is in, the card names and quantity the user has from the bank, and past transactions of the user at the bank.

Mortgage data module 710 may receive data of mortgages associated with the user. The data of mortgage may include, mortgage type, mortgage balance, bank of the mortgage, and accounts associated with the mortgage.

Loan data module 712 may receive data of loans the user is owning or ever owned. For example, the loan data may include auto loan data including bank account, credit card account, boat loan data, and other loan data and associated financial data.

Each of transaction history module 704, credit report module 706, bank specific module 708, mortgage data module 710, and loan data module 712 can provide corresponding data to machine learning algorithm 702. In turn, machine learning algorithm 702 may make a determination regarding whether the user has payment instruments, how many payment instruments the user has, and where those payment instruments are located, and so on. In an embodiment, the machine learning algorithms employed can include at least one selected from the group of gradient boosting machine, logistic regression, neural networks, and a combination thereof, however, it is understood that other machine learning algorithms can be utilized.

Machine learning model system 700 described herein can utilize a Bidirectional Encoder Representations from Transformers (BERT) models. BERT models utilize use multiple layers of so called “attention mechanisms” to process textual data and make predictions. These attention mechanisms effectively allow the BERT model to learn and assign more importance to words from the text input that are more important in making whatever inference is trying to be made.

Machine learning model 700 described herein may utilize various neural networks, such as convolutional neural networks (“CNNs”) or recurrent neural networks (“RNNs”), to generate the exemplary models. A CNN may include one or more convolutional layers (e.g., often with a subsampling step) and then followed by one or more fully connected layers as in a standard multilayer neural network. CNNs may utilize local connections, and may have tied weights followed by some form of pooling which may result in translation invariant features.

A RNN is a class of artificial neural network where connections between nodes form a directed graph along a sequence. This facilitates the determination of temporal dynamic behavior for a time sequence. Unlike feedforward neural networks, RNNs may use their internal state (e.g., memory) to process sequences of inputs. A RNN may generally refer to two broad classes of networks with a similar general structure, where one is finite impulse and the other is infinite impulse. Both classes of networks exhibit temporal dynamic behavior. A finite impulse recurrent network may be, or may include, a directed acyclic graph that may be unrolled and replaced with a strictly feedforward neural network, while an infinite impulse recurrent network may be, or may include, a directed cyclic graph that may not be unrolled. Both finite impulse and infinite impulse recurrent networks may have additional stored state, and the storage may be under the direct control of the neural network. The storage may also be replaced by another network or graph, which may incorporate time delays or may have feedback loops. Such controlled states may be referred to as gated state or gated memory, and may be part of long short-term memory networks (“LSTMs”) and gated recurrent units.

RNNs may be similar to a network of neuron-like nodes organized into successive “layers,” each node in a given layer being connected with a directed e.g., (one-way) connection to every other node in the next successive layer. Each node (e.g., neuron) may have a time-varying real-valued activation. Each connection (e.g., synapse) may have a modifiable real valued weight. Nodes may either be (i) input nodes (e.g., receiving data from outside the network), (ii) output nodes (e.g., yielding results), or (iii) hidden nodes (e.g., that may modify the data enroute from input to output). RNNs may accept an input vector x and give an output vector y. However, the output vectors are based not only by the input provided in, but also on the entire history of inputs that have been provided in in the past.

For supervised learning in discrete time settings, sequences of real-valued input vectors may arrive at the input nodes, one vector at a time. At any given time step, each non-input unit may compute its current activation (e.g., result) as a nonlinear function of the weighted sum of the activations of all units that connect to it. Supervisor-given target activations may be supplied for some output units at certain time steps. For example, if the input sequence is a speech signal corresponding to a spoken digit, the final target output at the end of the sequence may be a label classifying the digit. In reinforcement learning settings, no teacher provides target signals. Instead, a fitness function, or reward function, may be used to evaluate the RNNs performance, which may influence its input stream through output units connected to actuators that may affect the environment. Each sequence may produce an error as the sum of the deviations of all target signals from the corresponding activations computed by the network. For a training set of numerous sequences, the total error may be the sum of the errors of all individual sequences.

The models described herein may be trained on one or more training datasets, each of which may comprise one or more types of data. In some examples, the training datasets may comprise previously-collected data, such as data collected from previous uses of the same type of systems described herein and data collected from different types of systems. In other examples, the training datasets may comprise continuously-collected data based on the current operation of the instant system and continuously-collected data from the operation of other systems. In some examples, the training dataset may include anticipated data, such as the anticipated future workloads, currently scheduled workloads, and planned future workloads, for the instant system and/or other systems. In other examples, the training datasets can include previous predictions for the instant system and other types of system, and may further include results data indicative of the accuracy of the previous predictions. In accordance with these examples, machine learning model 700 described herein may be trained prior to use and the training may continue with updated data sets that reflect additional information.

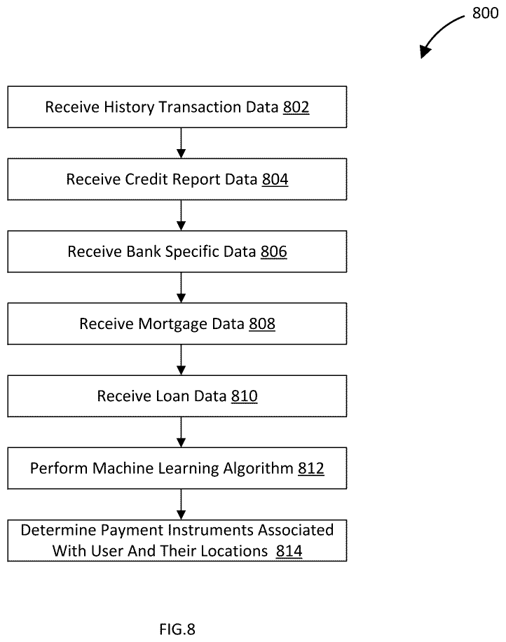

FIG. 8 illustrates a flow chart of an example method 800 for machine learning analysis for determining payment instruments and their locations in accordance with embodiments discussed herein. Method 800 may be performed by machine learning model 700, and include the following steps.

In block 802, transaction history module 704 can receive history transaction data of the user, that is, data of past transactions of the user. The data of past transactions can include, but are not limited to, locations of past transactions, dates of past transactions, times of past transactions, billing addresses of past transactions, shipping addresses of past transactions, amounts of past transactions, frequency of past transactions, cards used for past transactions, products or services included in past transactions, and returns or refunds of past transactions, a card number of a card used for past transactions, a card expiration date of the card used for past transactions, a cardholder name of the card used for past transactions, a card verification value (CVV) of the card used for past transactions.

In block 804, credit report module 706 can receive data about the credit report of the user. The credit report data may include, opened accounts, closed accounts, account balances, credit scores.

In block 806, bank specific data module 708 can obtain data specific to banks the user is associated with. The specific data of bank may include a location of the bank, a type of the bank, an industry in which the bank is in, the card names and quantity the user has from the bank, and past transactions of the user at the bank.

In block 808, mortgage data module 710 may receive data of mortgages associated with the user. The data of mortgage may include, mortgage type, mortgage balance, bank of the mortgage, and accounts associated with the mortgage.

In block 810, loan data module 712 may receive data of loans the user is owning or ever owned. For example, the loan data may include auto loan data including bank account, credit card account, boat loan data, and other loan data and associated financial data.

Each of transaction history module 704, credit report module 706, bank specific module 708, mortgage data module 710, and loan data module 712 can provide corresponding data to machine learning algorithm 702. In block 812, machine learning algorithm 702 can be performed with the above data.

In turn, in block 814, machine learning algorithm 702 may make a determination regarding whether the user has payment instruments, how many payment instruments the user has, and where those payment instruments are located, and so on. In an embodiment, the machine learning algorithms employed can include at least one selected from the group of gradient boosting machine, logistic regression, neural networks, and a combination thereof, however, it is understood that other machine learning algorithms can be utilized.

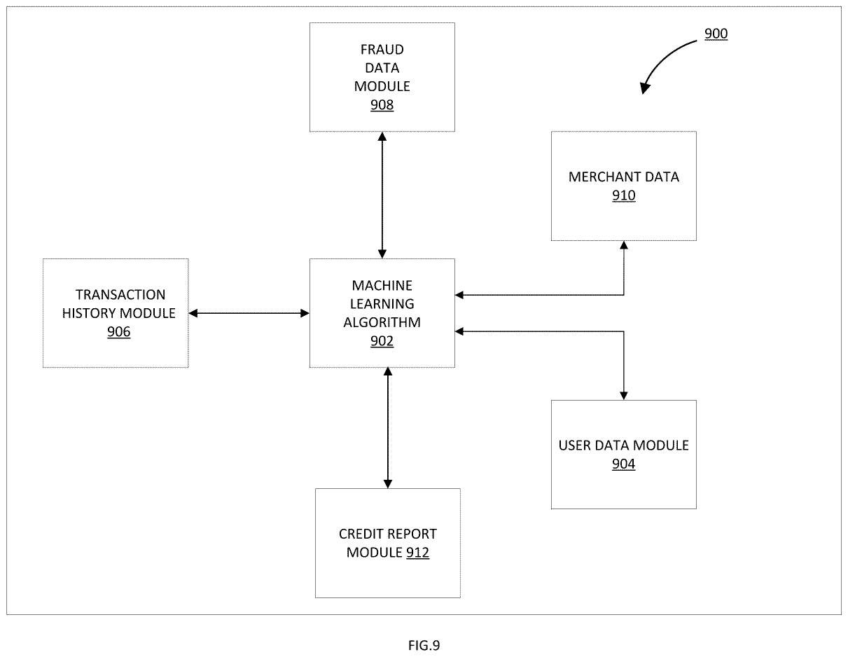

FIG. 9 illustrates a block diagram of an example machine learning model system 900 for determining payment instrument information and step-up methods configured to operate in accordance with embodiments discussed herein. Machine learning model system 900 may include machine learning algorithm 902. Machine learning algorithm 902 may include a communication interface as well as an algorithm processor coupled to a plurality of modules including user data module 904, transaction history module 906, fraud data module 908, merchant data module 910, and credit report module 912. The machine learning model system 900 may be performed by first payment facilitator 114 or second payment facilitator 118.

User data module 904 may receive user data. The user data may include, the user data can include user name, phone number, shipping address, home address, billing address, email address, date and time of an merchant account created with the merchant, login credentials of the user for the merchant account, and so forth.

Transaction history module 906 can receive data of past transactions of the user. The data of past transactions can include, but are not limited to, locations of past transactions, dates of past transactions, times of past transactions, billing addresses of past transactions, shipping addresses of past transactions, amounts of past transactions, frequency of past transactions, cards used for past transactions, products or services included in past transactions, and returns or refunds of past transactions, a card number of a card used for past transactions, a card expiration date of the card used for past transactions, a cardholder name of the card used for past transactions, a card verification value (CVV) of the card used for past transactions.

Fraud data module 908 may receive, store and process fraud-related data of the user and/or the merchant. The fraud-related data can include fraud history of the user, a type of the fraud, date and time when the fraud occurs, a location where the fraud happens, which card involved in the fraud, what measures the merchant takes for the fraud, a fund amount involved in the fraud, and a frequency of fraud happening with the user and/or the merchant.

Merchant data module 910 may receive data specific to the merchant. The data specific to the merchant can include a location of the merchant, a type of the merchant, an industry in which the merchant is in, the user name of the user shopping regularly at the merchant, the card number the user uses for shopping regularly at the merchant, the billing addresses and shipping addresses of the user regularly shopping at the merchant, past transactions of the user regularly shopping at the merchant, and a device binding relationship between a device (e.g., user device 102) of the user and merchant device 104 of the merchant.

Credit report module 912 can receive data about the credit report of the user. The credit report data may include, opened accounts, closed accounts, account balances, credit scores.

Each of user data module 904, transaction history module 906, fraud data module 908, merchant data module 910, and credit report module 912 can provide corresponding data to machine learning algorithm 902. In turn, machine learning algorithm 902 may generate payment instrument information or credentials of the payment instruments and determine what step-up authentication methods are needed for further authenticating the user. In an embodiment, the machine learning algorithms employed can include at least one selected from the group of gradient boosting machine, logistic regression, neural networks, and a combination thereof, however, it is understood that other machine learning algorithms can be utilized.

Machine learning model system 900 described herein can utilize a Bidirectional Encoder Representations from Transformers (BERT) models. BERT models utilize use multiple layers of so called “attention mechanisms” to process textual data and make predictions. These attention mechanisms effectively allow the BERT model to learn and assign more importance to words from the text input that are more important in making whatever inference is trying to be made.

Machine learning model 900 described herein may utilize various neural networks, such as convolutional neural networks (“CNNs”) or recurrent neural networks (“RNNs”), to generate the exemplary models. A CNN may include one or more convolutional layers (e.g., often with a subsampling step) and then followed by one or more fully connected layers as in a standard multilayer neural network. CNNs may utilize local connections, and may have tied weights followed by some form of pooling which may result in translation invariant features.

A RNN is a class of artificial neural network where connections between nodes form a directed graph along a sequence. This facilitates the determination of temporal dynamic behavior for a time sequence. Unlike feedforward neural networks, RNNs may use their internal state (e.g., memory) to process sequences of inputs. A RNN may generally refer to two broad classes of networks with a similar general structure, where one is finite impulse and the other is infinite impulse. Both classes of networks exhibit temporal dynamic behavior. A finite impulse recurrent network may be, or may include, a directed acyclic graph that may be unrolled and replaced with a strictly feedforward neural network, while an infinite impulse recurrent network may be, or may include, a directed cyclic graph that may not be unrolled. Both finite impulse and infinite impulse recurrent networks may have additional stored state, and the storage may be under the direct control of the neural network. The storage may also be replaced by another network or graph, which may incorporate time delays or may have feedback loops. Such controlled states may be referred to as gated state or gated memory, and may be part of long short-term memory networks (“LSTMs”) and gated recurrent units.

RNNs may be similar to a network of neuron-like nodes organized into successive “layers,” each node in a given layer being connected with a directed e.g., (one-way) connection to every other node in the next successive layer. Each node (e.g., neuron) may have a time-varying real-valued activation. Each connection (e.g., synapse) may have a modifiable real valued weight. Nodes may either be (i) input nodes (e.g., receiving data from outside the network), (ii) output nodes (e.g., yielding results), or (iii) hidden nodes (e.g., that may modify the data enroute from input to output). RNNs may accept an input vector x and give an output vector y. However, the output vectors are based not only by the input provided in, but also on the entire history of inputs that have been provided in in the past.

For supervised learning in discrete time settings, sequences of real-valued input vectors may arrive at the input nodes, one vector at a time. At any given time step, each non-input unit may compute its current activation (e.g., result) as a nonlinear function of the weighted sum of the activations of all units that connect to it. Supervisor-given target activations may be supplied for some output units at certain time steps. For example, if the input sequence is a speech signal corresponding to a spoken digit, the final target output at the end of the sequence may be a label classifying the digit. In reinforcement learning settings, no teacher provides target signals. Instead, a fitness function, or reward function, may be used to evaluate the RNNs performance, which may influence its input stream through output units connected to actuators that may affect the environment. Each sequence may produce an error as the sum of the deviations of all target signals from the corresponding activations computed by the network. For a training set of numerous sequences, the total error may be the sum of the errors of all individual sequences.

The models described herein may be trained on one or more training datasets, each of which may comprise one or more types of data. In some examples, the training datasets may comprise previously-collected data, such as data collected from previous uses of the same type of systems described herein and data collected from different types of systems. In other examples, the training datasets may comprise continuously-collected data based on the current operation of the instant system and continuously-collected data from the operation of other systems. In some examples, the training dataset may include anticipated data, such as the anticipated future workloads, currently scheduled workloads, and planned future workloads, for the instant system and/or other systems. In other examples, the training datasets can include previous predictions for the instant system and other types of system, and may further include results data indicative of the accuracy of the previous predictions. In accordance with these examples, machine learning model 900 described herein may be trained prior to use and the training may continue with updated data sets that reflect additional information.

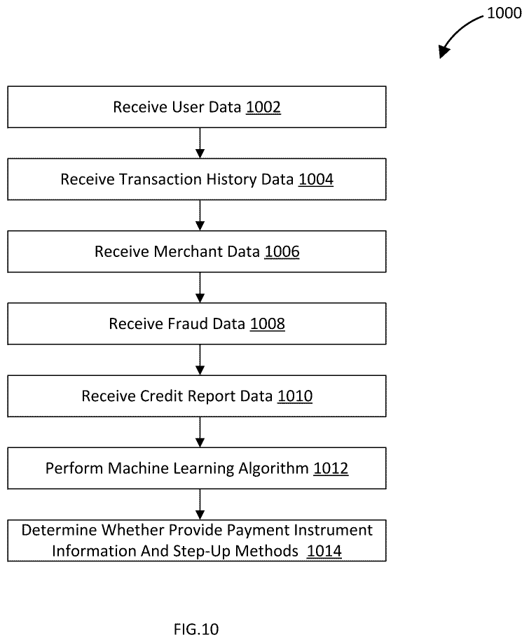

FIG. 10 illustrates a flow chart of an example method 1000 for machine learning analysis for determining payment instrument information and step-up methods in accordance with embodiments discussed herein. Method 1000 may be performed by machine learning model 900, and include the following steps.

In block 1002, user data module 904 may receive user data. The user data may include user name, phone number, shipping address, home address, billing address, email address, date and time of an merchant account created with the merchant, login credentials of the user for the merchant account, and so forth.

In block 1004, transaction history module 906 can receive data of past transactions of the user. The data of past transactions can include, but are not limited to, locations of past transactions, dates of past transactions, times of past transactions, billing addresses of past transactions, shipping addresses of past transactions, amounts of past transactions, frequency of past transactions, cards used for past transactions, products or services included in past transactions, and returns or refunds of past transactions, a card number of a card used for past transactions, a card expiration date of the card used for past transactions, a cardholder name of the card used for past transactions, a card verification value (CVV) of the card used for past transactions.

In block 1006, merchant data module 910 may receive data specific to the merchant. The data specific to the merchant can include a location of the merchant, a type of the merchant, an industry in which the merchant is in, the user name of the user shopping regularly at the merchant, the card number the user uses for shopping regularly at the merchant, the billing addresses and shipping addresses of the user regularly shopping at the merchant, past transactions of the user regularly shopping at the merchant, and a device binding relationship between a device (e.g., user device 102) of the user and merchant device 104 of the merchant.

In block 1008, fraud data module 908 may receive, store and process fraud-related data of the user and/or the merchant. The fraud-related data can include fraud history of the user, a type of the fraud, date and time when the fraud occurs, a location where the fraud happens, which card involved in the fraud, what measures the merchant takes for the fraud, a fund amount involved in the fraud, and a frequency of fraud happening with the user and/or the merchant.

In block 1010, credit report module 912 can receive data about the credit report of the user. The credit report data may include, opened accounts, closed accounts, account balances, credit scores.

Each of user data module 904, transaction history module 906, fraud data module 908, merchant data module 910, and credit report module 912 can provide corresponding data to machine learning algorithm 902. In block 1012, machine learning algorithm 902 is performed with the above data.

In turn, in block 1014, machine learning algorithm 902 may generate payment instrument information or credentials of the payment instruments and determine what step-up authentication methods are needed for further authenticating the user. In an embodiment, the machine learning algorithms employed can include at least one selected from the group of gradient boosting machine, logistic regression, neural networks, and a combination thereof, however, it is understood that other machine learning algorithms can be utilized.

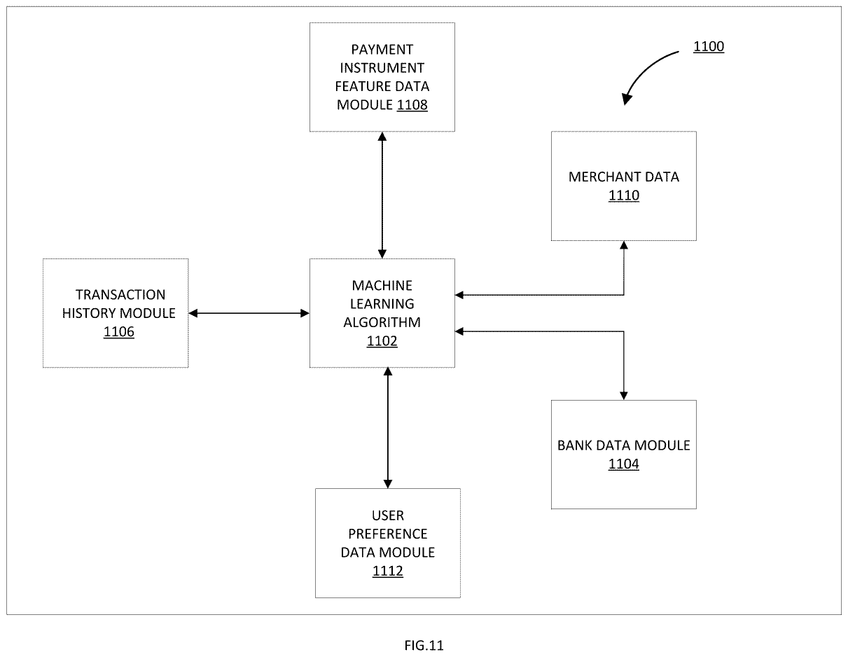

FIG. 11 illustrates a block diagram of an example machine learning model system 1100 for determining token ranking configured to operate in accordance with embodiments discussed herein. Machine learning model system 1100 may include machine learning algorithm 1102. Machine learning algorithm 1102 may include a communication interface as well as an algorithm processor coupled to a plurality of modules including bank data module 1104, transaction history module 1106, payment instrument feature data module 1108, merchant data module system 1110, and user preference module 1112. The machine learning model 1100 may be performed by token creation device 110.

Bank data module 1104 may obtain data specific to banks the user is associated with. The specific data of bank may include a location of the bank, a type of the bank, an industry in which the bank is in, the card names and quantity the user has from the bank, and past transactions of the user at the bank.

Transaction history module 1106 can receive data of past transactions of the user. The data of past transactions can include, but are not limited to, locations of past transactions, dates of past transactions, times of past transactions, billing addresses of past transactions, shipping addresses of past transactions, amounts of past transactions, frequency of past transactions, cards used for past transactions, products or services included in past transactions, and returns or refunds of past transactions, a card number of a card used for past transactions, a card expiration date of the card used for past transactions, a cardholder name of the card used for past transactions, a card verification value (CVV) of the card used for past transactions.

Payment instrument feature data module 1108 may receive, store and process payment instrument feature data. The payment instrument feature data may include credit card type, debit card type, credit limit of card, reward type of card, issuers of card, and usage limitations of card.

Merchant data module system 1110 may receive data specific to the merchant. The data specific to the merchant can include a location of the merchant, a type of the merchant, an industry in which the merchant is in, the user name of the user shopping regularly at the merchant, the card number the user uses for shopping regularly at the merchant, the billing addresses and shipping addresses of the user regularly shopping at the merchant, past transactions of the user regularly shopping at the merchant, and a device binding relationship between a device (e.g., user device 102) of the user and merchant device 104 of the merchant.

User preference module 1112 can receive data about user preference. The user preference data may include, what type of card the user prefers to use, what card reward the user prefers, which bank card the user prefers to use, what credit limit of card the user prefers, and so forth.

Each of bank data module 1104, transaction history module 1106, payment instrument feature data module 1108, merchant data module 1110, and user preference module 1112, can provide corresponding data to machine learning algorithm 1102. In turn, machine learning algorithm 1102 may generate a ranking of the tokens associated with the payment instruments. In an embodiment, the machine learning algorithms employed can include at least one selected from the group of gradient boosting machine, logistic regression, neural networks, and a combination thereof, however, it is understood that other machine learning algorithms can be utilized.

Machine learning model system 1100 described herein can utilize a Bidirectional Encoder Representations from Transformers (BERT) models. BERT models utilize use multiple layers of so called “attention mechanisms” to process textual data and make predictions. These attention mechanisms effectively allow the BERT model to learn and assign more importance to words from the text input that are more important in making whatever inference is trying to be made.

Machine learning model 1100 described herein may utilize various neural networks, such as convolutional neural networks (“CNNs”) or recurrent neural networks (“RNNs”), to generate the exemplary models. A CNN may include one or more convolutional layers (e.g., often with a subsampling step) and then followed by one or more fully connected layers as in a standard multilayer neural network. CNNs may utilize local connections, and may have tied weights followed by some form of pooling which may result in translation invariant features.

A RNN is a class of artificial neural network where connections between nodes form a directed graph along a sequence. This facilitates the determination of temporal dynamic behavior for a time sequence. Unlike feedforward neural networks, RNNs may use their internal state (e.g., memory) to process sequences of inputs. A RNN may generally refer to two broad classes of networks with a similar general structure, where one is finite impulse and the other is infinite impulse. Both classes of networks exhibit temporal dynamic behavior. A finite impulse recurrent network may be, or may include, a directed acyclic graph that may be unrolled and replaced with a strictly feedforward neural network, while an infinite impulse recurrent network may be, or may include, a directed cyclic graph that may not be unrolled. Both finite impulse and infinite impulse recurrent networks may have additional stored state, and the storage may be under the direct control of the neural network. The storage may also be replaced by another network or graph, which may incorporate time delays or may have feedback loops. Such controlled states may be referred to as gated state or gated memory, and may be part of long short-term memory networks (“LSTMs”) and gated recurrent units.

RNNs may be similar to a network of neuron-like nodes organized into successive “layers,” each node in a given layer being connected with a directed e.g., (one-way) connection to every other node in the next successive layer. Each node (e.g., neuron) may have a time-varying real-valued activation. Each connection (e.g., synapse) may have a modifiable real valued weight. Nodes may either be (i) input nodes (e.g., receiving data from outside the network), (ii) output nodes (e.g., yielding results), or (iii) hidden nodes (e.g., that may modify the data enroute from input to output). RNNs may accept an input vector x and give an output vector y. However, the output vectors are based not only by the input provided in, but also on the entire history of inputs that have been provided in in the past.

For supervised learning in discrete time settings, sequences of real-valued input vectors may arrive at the input nodes, one vector at a time. At any given time step, each non-input unit may compute its current activation (e.g., result) as a nonlinear function of the weighted sum of the activations of all units that connect to it. Supervisor-given target activations may be supplied for some output units at certain time steps. For example, if the input sequence is a speech signal corresponding to a spoken digit, the final target output at the end of the sequence may be a label classifying the digit. In reinforcement learning settings, no teacher provides target signals. Instead, a fitness function, or reward function, may be used to evaluate the RNNs performance, which may influence its input stream through output units connected to actuators that may affect the environment. Each sequence may produce an error as the sum of the deviations of all target signals from the corresponding activations computed by the network. For a training set of numerous sequences, the total error may be the sum of the errors of all individual sequences.

The models described herein may be trained on one or more training datasets, each of which may comprise one or more types of data. In some examples, the training datasets may comprise previously-collected data, such as data collected from previous uses of the same type of systems described herein and data collected from different types of systems. In other examples, the training datasets may comprise continuously-collected data based on the current operation of the instant system and continuously-collected data from the operation of other systems. In some examples, the training dataset may include anticipated data, such as the anticipated future workloads, currently scheduled workloads, and planned future workloads, for the instant system and/or other systems. In other examples, the training datasets can include previous predictions for the instant system and other types of system, and may further include results data indicative of the accuracy of the previous predictions. In accordance with these examples, machine learning model 1100 described herein may be trained prior to use and the training may continue with updated data sets that reflect additional information.

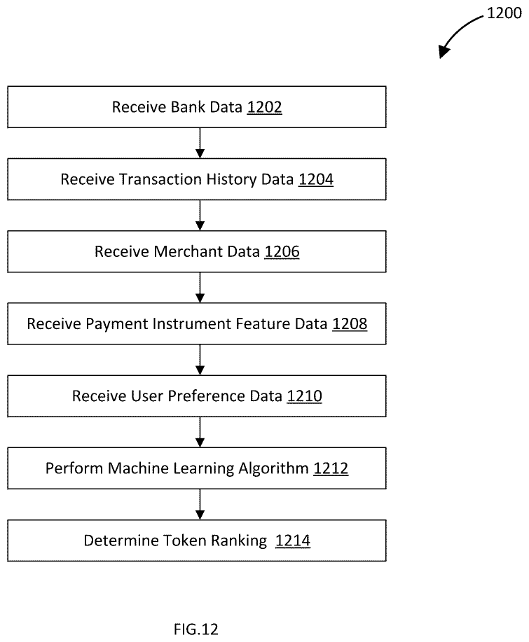

FIG. 12 illustrates a flow chart of an example method 1200 for machine learning analysis for determining a token ranking in accordance with embodiments discussed herein. Method 1200 may be performed by machine learning model 1100, and include the following steps.

In block 1202, bank data module 1104 may obtain data specific to banks the user is associated with. The specific data of bank may include a location of the bank, a type of the bank, an industry in which the bank is in, the card names and quantity the user has from the bank, and past transactions of the user at the bank.

In block 1204, transaction history module 1106 can receive data of past transactions of the user. The data of past transactions can include, but are not limited to, locations of past transactions, dates of past transactions, times of past transactions, billing addresses of past transactions, shipping addresses of past transactions, amounts of past transactions, frequency of past transactions, cards used for past transactions, products or services included in past transactions, and returns or refunds of past transactions, a card number of a card used for past transactions, a card expiration date of the card used for past transactions, a cardholder name of the card used for past transactions, a card verification value (CVV) of the card used for past transactions.

In block 1206, merchant data module 1110 may receive data specific to the merchant. The data specific to the merchant can include a location of the merchant, a type of the merchant, an industry in which the merchant is in, the user name of the user shopping regularly at the merchant, the card number the user uses for shopping regularly at the merchant, the billing addresses and shipping addresses of the user regularly shopping at the merchant, past transactions of the user regularly shopping at the merchant, and a device binding relationship between a device (e.g., user device 102) of the user and merchant device 104 of the merchant.

In block 1208, payment instrument feature data module 1108 may receive, store and process payment instrument feature data. The payment instrument feature data may include credit card type, debit card type, credit limit of card, reward type of card, issuers of card, and usage limitations of card.

In block 1210, user preference module 1112 can receive data about user preference. The user preference data may include, what type of card the user prefers to use, what card reward the user prefers, which bank card the user prefers to use, what credit limit of card the user prefers, and so forth.

Each of bank data module 1104, transaction history module 1106, payment instrument feature data module 1108, merchant data module 1110, and user preference module 1112, can provide corresponding data to machine learning algorithm 1102. In block 1212, machine learning algorithm 1102 can be performed with the above data.

In turn, in block 1214, machine learning algorithm 1102 may generate a ranking of the tokens associated with the payment instruments. In an embodiment, the machine learning algorithms employed can include at least one selected from the group of gradient boosting machine, logistic regression, neural networks, and a combination thereof, however, it is understood that other machine learning algorithms can be utilized.

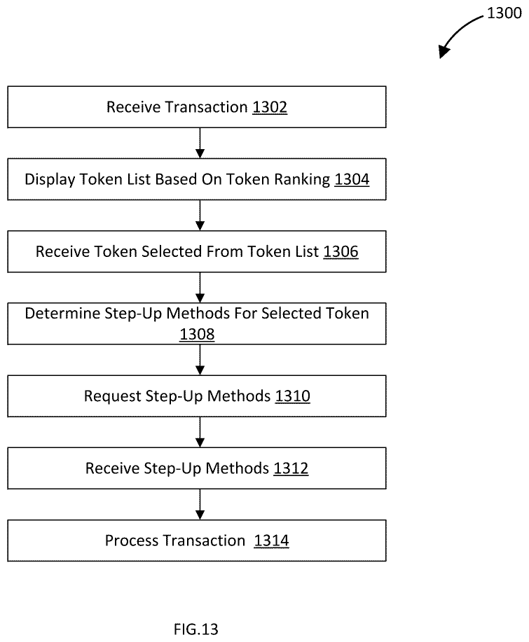

FIG. 13 illustrates a flow chart of an example method 1300 of using tokens for checking out in accordance with embodiments discussed herein. Method 1300 may be performed by merchant device 104 as shown in FIG. 1.

In step 1302, merchant device 104 may receive a transaction. For example, a user may make a purchase and check out on merchant device 104. Merchant device 104 receives the purchase.

In step 1304, merchant device 104 may display to the user a token list based on the token ranking. When the user is ready to check out on merchant device 104 for the purchase, merchant device 104 may display a token list including all the payment tokens associated with the user's payment instruments. The token list display may be based on the token ranking. For example, the most preferable or possibly accepted token is displayed on the top of the token list.

In step 1306, merchant device 104 receives a selected token selected by the user from the token list. The user may select a token corresponding to a payment instrument the user wants to use for the purchase. For example, the user may want to pay for the purchase using a credit card with travelling benefit, so the user can select a token corresponding to that card having travelling benefit. The user may want to pay for the purchase using a credit card with maximum reward points, so the user can select a token corresponding to that card having maximum reward points.

In step 1308, merchant device 104 may determine step-up authentication methods for the selected token. Upon receiving a selection of a token by the user, merchant device 104 may determine what step-up authentications are required for the selected token.

For example, the payment instrument corresponding to the selected token may require a one-time passcode verification of the user, in step 1310, so merchant device 104 may request the step-up method, that is, may transmit a one-time passcode to user device 102 associated with the user.

In step 1312, merchant device 1312 may receive the step-up method. That is, the user may enter the received one-time passcode to the check-out to be verified.

For another example, the payment instrument corresponding to the selected token may require the user to tap the payment instrument to merchant device 104 for verification of the user, so the user can tap the payment instrument to merchant device 104 to be verified.

In step 1314, upon completing the step-up methods successfully, merchant device 104 may proceed to process the transaction.

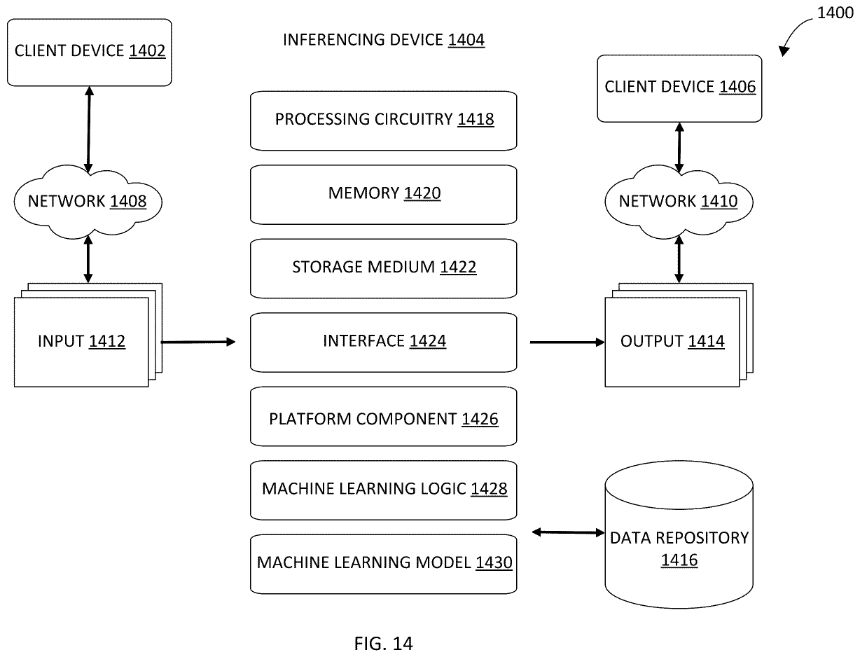

FIG. 14 illustrates an embodiment of a machine learning system 1400. The system 1400 is suitable for implementing one or more embodiments as described herein. In one embodiment, for example, the system 1400 is an AI/ML system suitable for generating and using payment tokens. The system 1400 can be the ML model systems 700, 900 and 1100.

The system 1400 comprises a set of M devices, where M is any positive integer. FIG. 14 depicts three devices (M=3), including a client device 1402, an inferencing device 1404, and a client device 1406. The inferencing device 1404 communicates information with the client device 1402 and the client device 1406 over a network 1408 and a network 1410, respectively. The information may include input 1412 from the client device 1402 and output 1414 to the client device 1406, or vice-versa. In one alternative, the input 1412 and the output 1414 are communicated between the same client device 1402 or client device 1406. In another alternative, the input 1412 and the output 1414 are stored in a data repository 1416. In yet another alternative, the input 1412 and the output 1414 are communicated via a platform component 1426 of the inferencing device 1404, such as an input/output (I/O) device (e.g., a touchscreen, a microphone, a speaker, etc.).

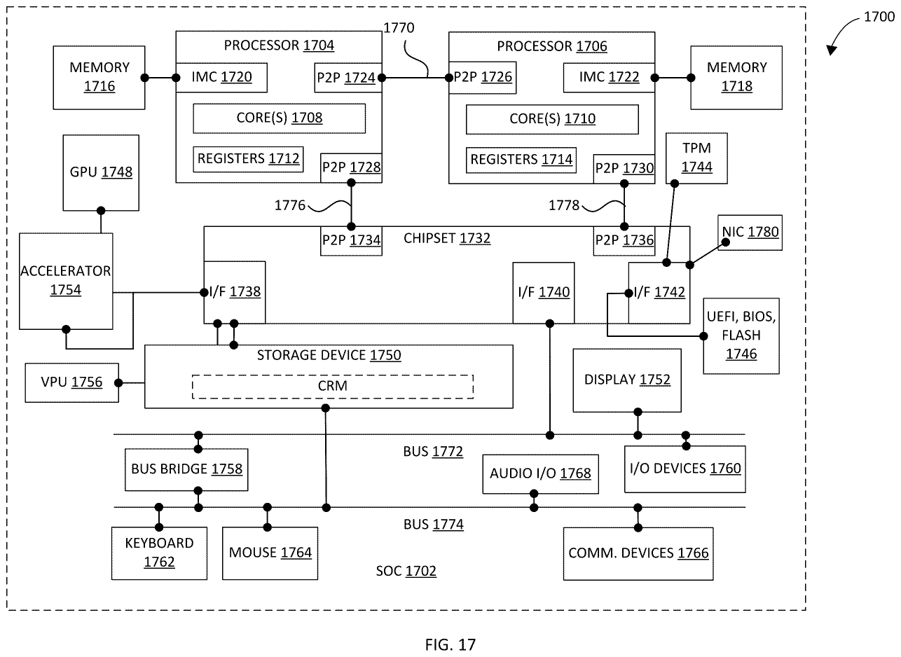

As depicted in FIG. 14, the inferencing device 1404 includes processing circuitry 1418, a memory 1420, a storage medium 1422, an interface 1424, a platform component 1426, ML logic 1428, and an ML model 1430. In some implementations, the inferencing device 1404 includes other components or devices as well. Examples for software elements and hardware elements of the inferencing device 1404 are described in more detail with reference to a computing architecture 1700 as depicted in FIG. 17. Embodiments are not limited to these examples.

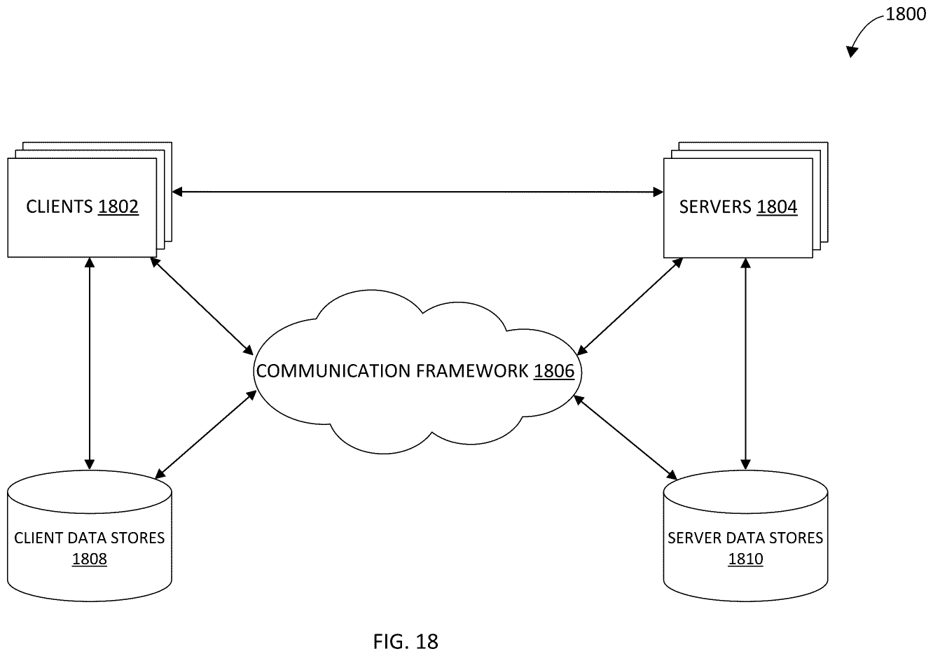

The inferencing device 1404 is generally arranged to receive an input 1412, process the input 1412 via one or more AI/ML techniques, and send an output 1414. The inferencing device 1404 receives the input 1412 from the client device 1402 via the network 1408, the client device 1406 via the network 1410, the platform component 1426 (e.g., a touchscreen as a text command or microphone as a voice command), the memory 1420, the storage medium 1422 or the data repository 1416. The inferencing device 1404 sends the output 1414 to the client device 1402 via the network 1408, the client device 1406 via the network 1410, the platform component 1426 (e.g., a touchscreen to present text, graphic or video information or speaker to reproduce audio information), the memory 1420, the storage medium 1422 or the data repository 1416. Examples for the software elements and hardware elements of the network 1408 and the network 1410 are described in more detail with reference to a communications architecture 1800 as depicted in FIG. 18. Embodiments are not limited to these examples.

The inferencing device 1404 includes ML logic 1428 and an ML model 1430 to implement various AI/ML techniques for various AI/ML tasks. The ML logic 1428 receives the input 1412, and processes the input 1412 using the ML model 1430. The ML model 1430 performs inferencing operations to generate an inference for a specific task from the input 1412. In some cases, the inference is part of the output 1414. The output 1414 is used by the client device 1402, the inferencing device 1404, or the client device 1406 to perform subsequent actions in response to the output 1414.

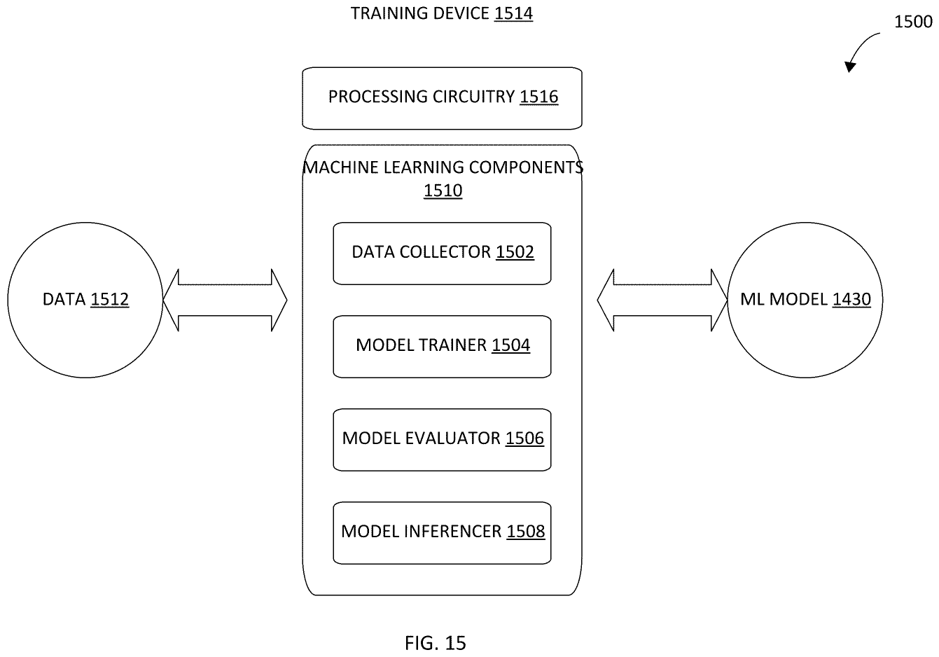

In various embodiments, the ML model 1430 is a trained ML model 1430 using a set of training operations. An example of training operations to train the ML model 1430 is described with reference to FIG. 15.

FIG. 15 illustrates a ML apparatus 1500. The apparatus 1500 depicts a training device 1514 suitable to generate a trained ML model 1430 for the inferencing device 1404 of the system 1400. As depicted in FIG. 15, the training device 1514 includes a processing circuitry 1516 and a set of ML components 1510 to support various AI/ML techniques, such as a data collector 1502, a model trainer 1504, a model evaluator 1506 and a model inferencer 1508.

In general, the data collector 1502 collects data 1512 from one or more data sources to use as training data for the ML model 1430. The data collector 1502 collects different types of data 1512, such as text information, audio information, image information, video information, graphic information, and so forth. The model trainer 1504 receives as input the collected data and uses a portion of the collected data as test data for an AI/ML algorithm to train the ML model 1430. The model evaluator 1506 evaluates and improves the trained ML model 1430 using a portion of the collected data as test data to test the ML model 1430. The model evaluator 1506 also uses feedback information from the deployed ML model 1430. The model inferencer 1508 implements the trained ML model 1430 to receive as input new unseen data, generate one or more inferences on the new data, and output a result such as an alert, a recommendation or other post-solution activity.

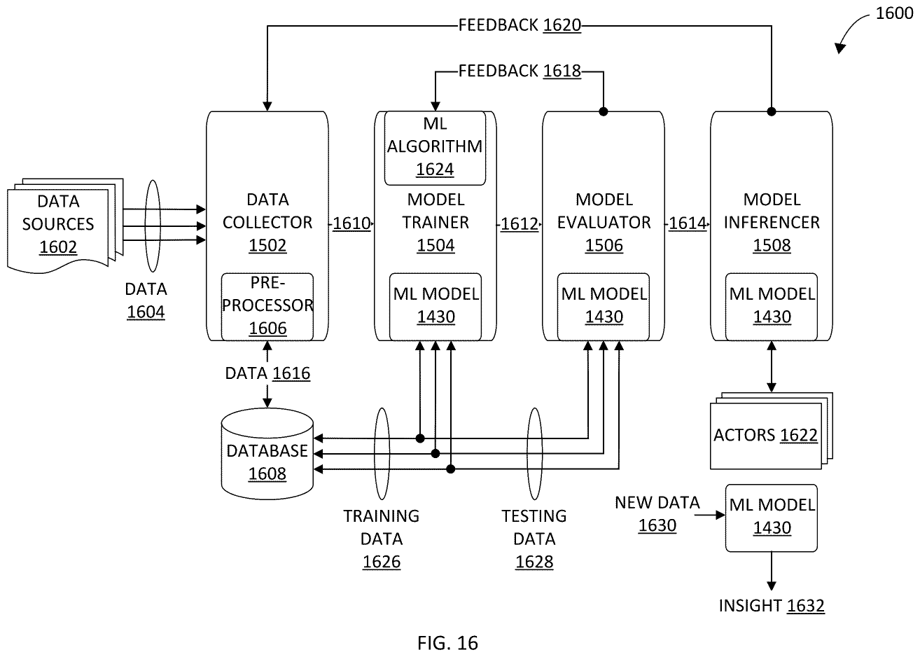

An exemplary AI/ML architecture for the ML components 1510 is described in more detail with reference to FIG. 16.

FIG. 16 illustrates an artificial intelligence architecture 1600 suitable for use by the training device 1514 to generate the ML model 1430 for deployment by the inferencing device 1404. The artificial intelligence architecture 1600 is an example of a system suitable for implementing various AI techniques and/or ML techniques to perform various inferencing tasks on behalf of the various devices of the system 1400.

AI is a science and technology based on principles of cognitive science, computer science and other related disciplines, which deals with the creation of intelligent machines that work and react like humans. AI is used to develop systems that can perform tasks that require human intelligence such as recognizing speech, vision and making decisions. AI can be seen as the ability for a machine or computer to think and learn, rather than following instructions. ML is a subset of AI that uses algorithms to enable machines to learn from existing data and generate insights or predictions from that data. ML algorithms are used to optimize machine performance in various tasks such as classifying, clustering, and forecasting. ML algorithms are used to create ML models that can accurately predict outcomes.

In general, the artificial intelligence architecture 1600 includes various machine or computer components (e.g., circuit, processor circuit, memory, network interfaces, compute platforms, input/output (I/O) devices, etc.) for an AI/ML system that are designed to work together to create a pipeline that can take in raw data, process it, train an ML model 1430, evaluate performance of the trained ML model 1430, and deploy the tested ML model 1430 as the trained ML model 1430 in a production environment, and continuously monitor and maintain it.

The ML model 1430 is a mathematical construct used to predict outcomes based on a set of input data. The ML model 1430 is trained using large volumes of training data 1626, and it can recognize patterns and trends in the training data 1626 to make accurate predictions. The ML model 1430 is derived from an ML algorithm 1624 (e.g., a neural network, decision tree, support vector machine, etc.). A data set is fed into the ML algorithm 1624 which trains an ML model 1430 to “learn” a function that produces mappings between a set of inputs and a set of outputs with a reasonably high accuracy. Given a sufficiently large enough set of inputs and outputs, the ML algorithm 1624 finds the function for a given task. This function may even be able to produce the correct output for input that it has not seen during training. A data scientist prepares the mappings, selects and tunes the ML algorithm 1624, and evaluates the resulting model performance. Once the ML logic 1428 is sufficiently accurate on test data, it can be deployed for production use.

The ML algorithm 1624 may comprise any ML algorithm suitable for a given AI task. Examples of ML algorithms may include supervised algorithms, unsupervised algorithms, or semi-supervised algorithms.

A supervised algorithm is a type of machine learning algorithm that uses labeled data to train a machine learning model. In supervised learning, the machine learning algorithm is given a set of input data and corresponding output data, which are used to train the model to make predictions or classifications. The input data is also known as the features, and the output data is known as the target or label. The goal of a supervised algorithm is to learn the relationship between the input features and the target labels, so that it can make accurate predictions or classifications for new, unseen data. Examples of supervised learning algorithms include: (1) linear regression which is a regression algorithm used to predict continuous numeric values, such as stock prices or temperature; (2) logistic regression which is a classification algorithm used to predict binary outcomes, such as whether a customer will purchase or not purchase a product; (3) decision tree which is a classification algorithm used to predict categorical outcomes by creating a decision tree based on the input features; or (4) random forest which is an ensemble algorithm that combines multiple decision trees to make more accurate predictions.

An unsupervised algorithm is a type of machine learning algorithm that is used to find patterns and relationships in a dataset without the need for labeled data. Unlike supervised learning, where the algorithm is provided with labeled training data and learns to make predictions based on that data, unsupervised learning works with unlabeled data and seeks to identify underlying structures or patterns. Unsupervised learning algorithms use a variety of techniques to discover patterns in the data, such as clustering, anomaly detection, and dimensionality reduction. Clustering algorithms group similar data points together, while anomaly detection algorithms identify unusual or unexpected data points. Dimensionality reduction algorithms are used to reduce the number of features in a dataset, making it easier to analyze and visualize. Unsupervised learning has many applications, such as in data mining, pattern recognition, and recommendation systems. It is particularly useful for tasks where labeled data is scarce or difficult to obtain, and where the goal is to gain insights and understanding from the data itself rather than to make predictions based on it.

Semi-supervised learning is a type of machine learning algorithm that combines both labeled and unlabeled data to improve the accuracy of predictions or classifications. In this approach, the algorithm is trained on a small amount of labeled data and a much larger amount of unlabeled data. The main idea behind semi-supervised learning is that labeled data is often scarce and expensive to obtain, whereas unlabeled data is abundant and easy to collect. By leveraging both types of data, semi-supervised learning can achieve higher accuracy and better generalization than either supervised or unsupervised learning alone. In semi-supervised learning, the algorithm first uses the labeled data to learn the underlying structure of the problem. It then uses this knowledge to identify patterns and relationships in the unlabeled data, and to make predictions or classifications based on these patterns. Semi-supervised learning has many applications, such as in speech recognition, natural language processing, and computer vision. It is particularly useful for tasks where labeled data is expensive or time-consuming to obtain, and where the goal is to improve the accuracy of predictions or classifications by leveraging large amounts of unlabeled data.

The ML algorithm 1624 of the artificial intelligence architecture 1600 is implemented using various types of ML algorithms including supervised algorithms, unsupervised algorithms, semi-supervised algorithms, or a combination thereof. A few examples of ML algorithms include support vector machine (SVM), random forests, naive Bayes, K-means clustering, neural networks, and so forth. A SVM is an algorithm that can be used for both classification and regression problems. It works by finding an optimal hyperplane that maximizes the margin between the two classes. Random forests is a type of decision tree algorithm that is used to make predictions based on a set of randomly selected features. Naive Bayes is a probabilistic classifier that makes predictions based on the probability of certain events occurring. K-Means Clustering is an unsupervised learning algorithm that groups data points into clusters. Neural networks is a type of machine learning algorithm that is designed to mimic the behavior of neurons in the human brain. Other examples of ML algorithms include a support vector machine (SVM) algorithm, a random forest algorithm, a naive Bayes algorithm, a K-means clustering algorithm, a neural network algorithm, an artificial neural network (ANN) algorithm, a convolutional neural network (CNN) algorithm, a recurrent neural network (RNN) algorithm, a long short-term memory (LSTM) algorithm, a deep learning algorithm, a decision tree learning algorithm, a regression analysis algorithm, a Bayesian network algorithm, a genetic algorithm, a federated learning algorithm, a distributed artificial intelligence algorithm, and so forth. Embodiments are not limited in this context.

As depicted in FIG. 16, the artificial intelligence architecture 1600 includes a set of data sources 1602 to source data 1604 for the artificial intelligence architecture 1600. Data sources 1602 may comprise any device capable generating, processing, storing or managing data 1604 suitable for a ML system. Examples of data sources 1602 include without limitation databases, web scraping, sensors and Internet of Things (IoT) devices, image and video cameras, audio devices, text generators, publicly available databases, private databases, and many other data sources 1602. The data sources 1602 may be remote from the artificial intelligence architecture 1600 and accessed via a network, local to the artificial intelligence architecture 1600 an accessed via a network interface, or may be a combination of local and remote data sources 1602.

The data sources 1602 source difference types of data 1604. By way of example and not limitation, the data 1604 includes structured data from relational databases, such as customer profiles, transaction histories, or product inventories. The data 1604 includes unstructured data from websites such as customer reviews, news articles, social media posts, or product specifications. The data 1604 includes data from temperature sensors, motion detectors, and smart home appliances. The data 1604 includes image data from medical images, security footage, or satellite images. The data 1604 includes audio data from speech recognition, music recognition, or call centers. The data 1604 includes text data from emails, chat logs, customer feedback, news articles or social media posts. The data 1604 includes publicly available datasets such as those from government agencies, academic institutions, or research organizations.

The data 1604 is typically in different formats such as structured, unstructured or semi-structured data. Structured data refers to data that is organized in a specific format or schema, such as tables or spreadsheets. Structured data has a well-defined set of rules that dictate how the data should be organized and represented, including the data types and relationships between data elements. Unstructured data refers to any data that does not have a predefined or organized format or schema. Unlike structured data, which is organized in a specific way, unstructured data can take various forms, such as text, images, audio, or video. Unstructured data can come from a variety of sources, including social media, emails, sensor data, and website content. Semi-structured data is a type of data that does not fit neatly into the traditional categories of structured and unstructured data. It has some structure but does not conform to the rigid structure of a traditional relational database. Semi-structured data is characterized by the presence of tags or metadata that provide some structure and context for the data.

The data sources 1602 are communicatively coupled to a data collector 1502. The data collector 1502 gathers relevant data 1604 from the data sources 1602. Once collected, the data collector 1502 may use a pre-processor 1606 to make the data 1604 suitable for analysis. This involves data cleaning, transformation, and feature engineering. Data preprocessing is a critical step in ML as it directly impacts the accuracy and effectiveness of the ML model 1430. The pre-processor 1606 receives the data 1604 as input, processes the data 1604, and outputs pre-processed data 1616 for storage in a database 1608. Examples for the database 1608 includes a hard drive, solid state storage, and/or random access memory (RAM).

The data collector 1502 is communicatively coupled to a model trainer 1504. The model trainer 1504 performs AI/ML model training, validation, and testing which may generate model performance metrics as part of the model testing procedure. The model trainer 1504 receives the pre-processed data 1616 as input 1610 or via the database 1608. The model trainer 1504 implements a suitable ML algorithm 1624 to train an ML model 1430 on a set of training data 1626 from the pre-processed data 1616. The training process involves feeding the pre-processed data 1616 into the ML algorithm 1624 to produce or optimize an ML model 1430. The training process adjusts its parameters until it achieves an initial level of satisfactory performance.

The model trainer 1504 is communicatively coupled to a model evaluator 1506. After an ML model 1430 is trained, the ML model 1430 needs to be evaluated to assess its performance. This is done using various metrics such as accuracy, precision, recall, and F1 score. The model trainer 1504 outputs the ML model 1430, which is received as input 1610 or from the database 1608. The model evaluator 1506 receives the ML model 1430 as input 1612, and it initiates an evaluation process to measure performance of the ML model 1430. The evaluation process includes providing feedback 1618 to the model trainer 1504. The model trainer 1504 re-trains the ML model 1430 to improve performance in an iterative manner.

The model evaluator 1506 is communicatively coupled to a model inferencer 1508. The model inferencer 1508 provides AI/ML model inference output (e.g., inferences, predictions or decisions). Once the ML model 1430 is trained and evaluated, it is deployed in a production environment where it is used to make predictions on new data. The model inferencer 1508 receives the evaluated ML model 1430 as input 1614. The model inferencer 1508 uses the evaluated ML model 1430 to produce insights or predictions on real data, which is deployed as a final production ML model 1430. The inference output of the ML model 1430 is use case specific. The model inferencer 1508 also performs model monitoring and maintenance, which involves continuously monitoring performance of the ML model 1430 in the production environment and making any necessary updates or modifications to maintain its accuracy and effectiveness. The model inferencer 1508 provides feedback 1618 to the data collector 1502 to train or re-train the ML model 1430. The feedback 1618 includes model performance feedback information, which is used for monitoring and improving performance of the ML model 1430.

Some or all of the model inferencer 1508 is implemented by various actors 1622 in the artificial intelligence architecture 1600, including the ML model 1430 of the inferencing device 1404, for example. The actors 1622 use the deployed ML model 1430 on new data to make inferences or predictions for a given task, and output an insight 1632. The actors 1622 implement the model inferencer 1508 locally, or remotely receives outputs from the model inferencer 1508 in a distributed computing manner. The actors 1622 trigger actions directed to other entities or to itself. The actors 1622 provide feedback 1620 to the data collector 1502 via the model inferencer 1508. The feedback 1620 comprise data needed to derive training data, inference data or to monitor the performance of the ML model 1430 and its impact to the network through updating of key performance indicators (KPIs) and performance counters.

As previously described with reference to FIGS. 1, 2, the systems 1400, 1500 implement some or all of the artificial intelligence architecture 1600 to support various use cases and solutions for various AI/ML tasks. In various embodiments, the training device 1514 of the apparatus 1500 uses the artificial intelligence architecture 1600 to generate and train the ML model 1430 for use by the inferencing device 1404 for the system 1400.

FIG. 17 illustrates an embodiment of a computing architecture 1700. Computing architecture 1700 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the computing architecture 1700 has a single processor with one core or more than one processor. Note that the term “processor” refers to a processor with a single core or a processor package with multiple processor cores. In at least one embodiment, the computing architecture 1700 is representative of the components of the system 1400. More generally, the computing architecture 1700 is configured to implement all logic, systems, logic flows, methods, apparatuses, and functionality described herein with reference to previous figures.

As used in this application, the terms “system” and “component” and “module” are intended to refer to a computer-related entity, either hardware, a combination of hardware and software, software, or software in execution, examples of which are provided by the exemplary computing architecture 1700. For example, a component is, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server are a component. One or more components reside within a process and/or thread of execution, and a component is localized on one computer and/or distributed between two or more computers. Further, components are communicatively coupled to each other by various types of communications media to coordinate operations. The coordination involves the uni-directional or bi-directional exchange of information. For instance, the components communicate information in the form of signals communicated over the communications media. The information is implemented as signals allocated to various signal lines. In such allocations, each message is a signal. Further embodiments, however, alternatively employ data messages. Such data messages may be sent across various connections. Exemplary connections include parallel interfaces, serial interfaces, and bus interfaces.

As shown in FIG. 17, computing architecture 1700 comprises a system-on-chip (SoC) 1702 for mounting platform components. System-on-chip (SoC) 1702 is a point-to-point (P2P) interconnect platform that includes a first processor 1704 and a second processor 1706 coupled via a point-to-point interconnect 1770 such as an Ultra Path Interconnect (UPI). In other embodiments, the computing architecture 1700 is another bus architecture, such as a multi-drop bus. Furthermore, each of processor 1704 and processor 1706 are processor packages with multiple processor cores including core(s) 1708 and core(s) 1710, respectively. While the computing architecture 1700 is an example of a two-socket (2S) platform, other embodiments include more than two sockets or one socket. For example, some embodiments include a four-socket (4S) platform or an eight-socket (8S) platform. Each socket is a mount for a processor and may have a socket identifier. Note that the term platform refers to a motherboard with certain components mounted such as the processor 1704 and chipset 1732. Some platforms include additional components and some platforms include sockets to mount the processors and/or the chipset. Furthermore, some platforms do not have sockets (e.g. SoC, or the like). Although depicted as a SoC 1702, one or more of the components of the SoC 1702 are included in a single die package, a multi-chip module (MCM), a multi-die package, a chiplet, a bridge, and/or an interposer. Therefore, embodiments are not limited to a SoC.

The processor 1704 and processor 1706 are any commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM® and Sony® Cell processors; and similar processors. Dual microprocessors, multi-core processors, and other multi-processor architectures are also employed as the processor 1704 and/or processor 1706. Additionally, the processor 1704 need not be identical to processor 1706.

Processor 1704 includes an integrated memory controller (IMC) 1720 and point-to-point (P2P) interface 1724 and P2P interface 1728. Similarly, the processor 1706 includes an IMC 1722 as well as P2P interface 1726 and P2P interface 1730. IMC 1720 and IMC 1722 couple the processor 1704 and processor 1706, respectively, to respective memories (e.g., memory 1716 and memory 1718). Memory 1716 and memory 1718 are portions of the main memory (e.g., a dynamic random-access memory (DRAM)) for the platform such as double data rate type 4 (DDR4) or type 5 (DDR5) synchronous DRAM (SDRAM). In the present embodiment, the memory 1716 and the memory 1718 locally attach to the respective processors (i.e., processor 1704 and processor 1706). In other embodiments, the main memory couple with the processors via a bus and shared memory hub. Processor 1704 includes registers 1712 and processor 1706 includes registers 1714.

Computing architecture 1700 includes chipset 1732 coupled to processor 1704 and processor 1706. Furthermore, chipset 1732 are coupled to storage device 1750, for example, via an interface (I/F) 1738. The I/F 1738 may be, for example, a Peripheral Component Interconnect-enhanced (PCIe) interface, a Compute Express Link ® (CXL) interface, or a Universal Chiplet Interconnect Express (UCIe) interface. Storage device 1750 stores instructions executable by circuitry of computing architecture 1700 (e.g., processor 1704, processor 1706, GPU 1748, accelerator 1754, vision processing unit 1756, or the like). For example, storage device 1750 can store instructions for the client device 202, the client device 206, the inferencing device 204, the training device 314, or the like.

Processor 1704 couples to the chipset 1732 via P2P interface 1728 and P2P 1734 while processor 1706 couples to the chipset 1732 via P2P interface 1730 and P2P 1736. Direct media interface (DMI) 1776 and DMI 1778 couple the P2P interface 1728 and the P2P 1734 and the P2P interface 1730 and P2P 1736, respectively. DMI 1776 and DMI 1778 is a high-speed interconnect that facilitates, e.g., eight Giga Transfers per second (GT/s) such as DMI 3.0. In other embodiments, the processor 1704 and processor 1706 interconnect via a bus.

The chipset 1732 comprises a controller hub such as a platform controller hub (PCH). The chipset 1732 includes a system clock to perform clocking functions and include interfaces for an I/O bus such as a universal serial bus (USB), peripheral component interconnects (PCIs), CXL interconnects, UCIe interconnects, interface serial peripheral interconnects (SPIs), integrated interconnects (I2Cs), and the like, to facilitate connection of peripheral devices on the platform. In other embodiments, the chipset 1732 comprises more than one controller hub such as a chipset with a memory controller hub, a graphics controller hub, and an input/output (I/O) controller hub.

In the depicted example, chipset 1732 couples with a trusted platform module (TPM) 1744 and UEFI, BIOS, FLASH circuitry 1746 via I/F 1742. The TPM 1744 is a dedicated microcontroller designed to secure hardware by integrating cryptographic keys into devices. The UEFI, BIOS, FLASH circuitry 1746 may provide pre-boot code. The I/F 1742 may also be coupled to a network interface circuit (NIC) 1780 for connections off-chip.

Furthermore, chipset 1732 includes the I/F 1738 to couple chipset 1732 with a high-performance graphics engine, such as, graphics processing circuitry or a graphics processing unit (GPU) 1748. In other embodiments, the computing architecture 1700 includes a flexible display interface (FDI) (not shown) between the processor 1704 and/or the processor 1706 and the chipset 1732. The FDI interconnects a graphics processor core in one or more of processor 1704 and/or processor 1706 with the chipset 1732.

The computing architecture 1700 is operable to communicate with wired and wireless devices or entities via the network interface (NIC) 180 using the IEEE 802 family of standards, such as wireless devices operatively disposed in wireless communication (e.g., IEEE 802.17 over-the-air modulation techniques). This includes at least Wi-Fi (or Wireless Fidelity), WiMax, and Bluetooth™ wireless technologies, 3G, 4G, LTE wireless technologies, among others. Thus, the communication is a predefined structure as with a conventional network or simply an ad hoc communication between at least two devices. Wi-Fi networks use radio technologies called IEEE 802.17x (a, b, g, n, ac, ax, etc.) to provide secure, reliable, fast wireless connectivity. A Wi-Fi network is used to connect computers to each other, to the Internet, and to wired networks (which use IEEE 802.3-related media and functions).

Additionally, accelerator 1754 and/or vision processing unit 1756 are coupled to chipset 1732 via I/F 1738. The accelerator 1754 is representative of any type of accelerator device (e.g., a data streaming accelerator, cryptographic accelerator, cryptographic co-processor, an offload engine, etc.). One example of an accelerator 1754 is the Intel® Data Streaming Accelerator (DSA). The accelerator 1754 is a device including circuitry to accelerate copy operations, data encryption, hash value computation, data comparison operations (including comparison of data in memory 1716 and/or memory 1718), and/or data compression. Examples for the accelerator 1754 include a USB device, PCI device, PCIe device, CXL device, UCIe device, and/or an SPI device. The accelerator 1754 also includes circuitry arranged to execute machine learning (ML) related operations (e.g., training, inference, etc.) for ML models. Generally, the accelerator 1754 is specially designed to perform computationally intensive operations, such as hash value computations, comparison operations, cryptographic operations, and/or compression operations, in a manner that is more efficient than when performed by the processor 1704 or processor 1706. Because the load of the computing architecture 1700 includes hash value computations, comparison operations, cryptographic operations, and/or compression operations, the accelerator 1754 greatly increases performance of the computing architecture 1700 for these operations.

The accelerator 1754 includes one or more dedicated work queues and one or more shared work queues (each not pictured). Generally, a shared work queue is configured to store descriptors submitted by multiple software entities. The software is any type of executable code, such as a process, a thread, an application, a virtual machine, a container, a microservice, etc., that share the accelerator 1754. For example, the accelerator 1754 is shared according to the Single Root I/O virtualization (SR-IOV) architecture and/or the Scalable I/O virtualization (S-IOV) architecture. Embodiments are not limited in these contexts. In some embodiments, software uses an instruction to atomically submit the descriptor to the accelerator 1754 via a non-posted write (e.g., a deferred memory write (DMWr)). One example of an instruction that atomically submits a work descriptor to the shared work queue of the accelerator 1754 is the ENQCMD command or instruction (which may be referred to as “ENQCMD” herein) supported by the Intel® Instruction Set Architecture (ISA). However, any instruction having a descriptor that includes indications of the operation to be performed, a source virtual address for the descriptor, a destination virtual address for a device-specific register of the shared work queue, virtual addresses of parameters, a virtual address of a completion record, and an identifier of an address space of the submitting process is representative of an instruction that atomically submits a work descriptor to the shared work queue of the accelerator 1754. The dedicated work queue may accept job submissions via commands such as the movdir64b instruction.

Various I/O devices 1760 and display 1752 couple to the bus 1772, along with a bus bridge 1758 which couples the bus 1772 to a second bus 1774 and an I/F 1740 that connects the bus 1772 with the chipset 1732. In one embodiment, the second bus 1774 is a low pin count (LPC) bus. Various input/output (I/O) devices couple to the second bus 1774 including, for example, a keyboard 1762, a mouse 1764 and communication devices 1766.

Furthermore, an audio I/O 1768 couples to second bus 1774. Many of the I/O devices 1760 and communication devices 1766 reside on the system-on-chip (SoC) 1702 while the keyboard 1762 and the mouse 1764 are add-on peripherals. In other embodiments, some or all the I/O devices 1760 and communication devices 1766 are add-on peripherals and do not reside on the system-on-chip (SoC) 1702.

FIG. 18 illustrates a block diagram of an exemplary communications architecture 1800 suitable for implementing various embodiments as previously described. The communications architecture 1800 includes various common communications elements, such as a transmitter, receiver, transceiver, radio, network interface, baseband processor, antenna, amplifiers, filters, power supplies, and so forth. The embodiments, however, are not limited to implementation by the communications architecture 1800.

As shown in FIG. 18, the communications architecture 1800 includes one or more clients 1802 and servers 1804. The clients 1802 and the servers 1804 are operatively connected to one or more respective client data stores 1808 and server data stores 1810 that can be employed to store information local to the respective clients 1802 and servers 1804, such as cookies and/or associated contextual information.

The clients 1802 and the servers 1804 communicate information between each other using a communication framework 1806. The communication framework 1806 implements any well-known communications techniques and protocols. The communication framework 1806 is implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 1806 implements various network interfaces arranged to accept, communicate, and connect to a communications network. A network interface is regarded as a specialized form of an input output interface. Network interfaces employ connection protocols including without limitation direct connect, Ethernet (e.g., thick, thin, twisted pair 10/200/1000 Base T, and the like), token ring, wireless network interfaces, cellular network interfaces, IEEE 802.11 network interfaces, IEEE 802.16 network interfaces, IEEE 802.20 network interfaces, and the like. Further, multiple network interfaces are used to engage with various communications network types. For example, multiple network interfaces are employed to allow for the communication over broadcast, multicast, and unicast networks. Should processing requirements dictate a greater amount speed and capacity, distributed network controller architectures are similarly employed to pool, load balance, and otherwise increase the communicative bandwidth required by clients 1802 and the servers 1804. A communications network is any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

The present disclosure may provide a payment token system. The payment token system comprises a token creation device. The token creation device comprises a processor and a memory containing an application for execution by the processor. The application is configured to: receive, from a merchant device, a request to create one or more payment tokens associated with a personal identifier of a user, in response to the request, create the one or more payment tokens without a payment instrument attached to the one or more payment tokens, transmit the one or more payment tokens to the merchant device, transmit, to a payment facilitator device, a request of payment information of one or more payment instruments of the user, the request including the personal identifier of the user, receive, from the payment facilitator device, the payment information of the one or more payment instruments of the user, in response to receiving the payment information, associate the payment information of the one or more payment instruments of the user with the one or more payment tokens, and store the payment information of the one or more payment instruments of the user and the one or more payment tokens in a token data store.

In some embodiments, the personal identifier of the user is generated in response to signing in or singing up by the user for a merchant account using a phone number or email address of the user.

In some embodiments, the payment instrument includes at least one selected from a group consisting of a credit card, a debit card, a gift card, a shopping card, and a bank account.

In some embodiments, the token creation device is associated with a bank, a payment processor, a payment network, or a merchant; and the one or more tokens are associated with the bank, the payment processor, the payment network, or the merchant.

In some embodiments, the application is configured to verify the user based on the personal identifier of the user.

In some embodiments, the payment information of the one or more payment instruments of the user includes a card number of a card, a bank account number associated with the card, an expiration date of the card, a card verification value of the card, or a billing address of the user.

In some embodiments, the token creation device includes a first machine learning model, and prior to transmitting, by the token creation device to the payment facilitator device, the request of payment information, the first machine learning model determines whether the user has the one or more payment instruments and where the one or more payment instruments are located.

In some embodiments, the first machine learning model determines whether the user has the one or more payment instruments and where the one or more payment instruments are located, includes: receiving history transaction data of the user; receiving credit report data of the user; receiving bank specific data associated with the user; receiving mortgage data of the user; receiving loan data of the user; performing a machine learning algorithm; and determining the one or more payment instruments associated with the user and their locations.

In some embodiments, the application is further configured to receive from the payment facilitator device one or more step-up methods associated with the one or more payment instruments of the user.

In some embodiments, the application is further configured to transmit the one or more step-up methods to the merchant device.

In some embodiments, the one or more step-up methods include a Short Message Service (SMS) message to a phone number of the user, a one-time passcode to the phone number of the user, and a tap of a contactless card.

In some embodiments, the token creation device includes a second machine learning model; and the second machine learning model generates a ranking of the one or more payment tokens associated with the one or more payment instruments.

In some embodiments, the second machine learning model generates a ranking of the one or more payment tokens associated with the one or more payment instruments, includes: receiving transaction history data of the user; receiving merchant data associated with the merchant device; receiving bank data associated with the user; receiving payment instrument feature data of the one or more payment instruments; receiving user preference data of the user; performing a machine learning algorithm; and determining the ranking of the one or more payment tokens.

In some embodiments, the ranking is indicative of a preference order by the user of the one or more payment instruments.

In some embodiments, the ranking is indicative of a recommendation order by the merchant device of the one or more payment instruments.

In some embodiments, the ranking is indicative of a recommendation order by the token creation device of the one or more payment instruments.

In some embodiments, the ranking is generated based on usage history of the one or more payment instruments, features associated with the one or more payment instruments, or a transaction pattern of the user.

In some embodiments, the application is configured to transmit the ranking of the one or more payment tokens to the merchant device.

The present disclosure also provides a payment token method. The payment token method can comprise: receiving, by an application executing on a token creation device from a merchant device, a request to create one or more payment tokens associated with a personal identifier of a user; in response to the request, creating, by the application, the one or more payment tokens without a payment instrument attached to the one or more payment tokens; transmitting, by the application to the merchant device, the one or more payment tokens; transmitting, by the application to a payment facilitator device, a request of payment information of one or more payment instruments of the user, the request including the personal identifier of the user; receiving, by the application device from the payment facilitator device, the payment information of the one or more payment instruments of the user; in response to receiving the payment information, associating, by the application, the payment information of the one or more payment instruments of the user with the one or more payment tokens; and storing, by the application, the payment information of the one or more payment instruments of the user and the one or more payment tokens in a token data store.

The present disclosure also provides a non-transitory computer-readable medium having computer-executable instructions stored thereon that, when executed by a token creation device comprising a processor, cause the token creation device to perform procedures comprising: receiving, from a merchant device, a request to create one or more payment tokens associated with a personal identifier of a user; in response to the request, creating the one or more payment tokens without a payment instrument attached to the one or more payment tokens; transmitting the one or more payment tokens to the merchant device; transmitting, to a payment facilitator device, a request of payment information of one or more payment instruments of the user, the request including the personal identifier of the user; receiving, from the payment facilitator device, the payment information of the one or more payment instruments of the user; in response to receiving the payment information, associating the payment information of the one or more payment instruments of the user with the one or more payment tokens; and storing the payment information of the one or more payment instruments of the user and the one or more payment tokens in a token data store.

The various elements of the devices as previously described herein may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

The various elements of the devices as previously described with reference to FIGS. 1-13 may include various hardware elements, software elements, or a combination of both. Examples of hardware elements may include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment may be implemented by representative instructions stored on a non-transitory machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

As used herein, the term “merchant” is not limited to a particular merchant or type of merchant. Rather, the term includes any type of merchant, vendor, or other entity involving in activities where products or services are sold or otherwise provided.

As used herein, the term “bank” is not limited to a financial institution or other type of entity. Rather, the term includes any type of financial institution, business or industrial organization, or other entity involved in the handling or processing of transactions.

As used herein, the term “account” is not limited to a particular type of account. Rather, it is understood that the term “account” can refer to a variety of accounts, including without limitation, a financial account (e.g., a credit account, a debit account), a membership account, a loyalty account, a subscription account, a services account, a utilities account, a transportation account, and a physical access account. It is further understood that the present disclosure is not limited to accounts issued by a particular entity.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

What is claimed is:

1 A payment token system, comprising:
a token creation device comprising a processor and a memory containing an application for execution by the processor,
wherein the application is configured to:
receive, from a merchant device, a request to create one or more payment tokens associated with a personal identifier of a user,
in response to the request, create the one or more payment tokens without a payment instrument attached to the one or more payment tokens,
transmit the one or more payment tokens to the merchant device,
transmit, to a payment facilitator device, a request of payment information of one or more payment instruments of the user, the request including the personal identifier of the user,
receive, from the payment facilitator device, the payment information of the one or more payment instruments of the user,
in response to receiving the payment information, associate the payment information of the one or more payment instruments of the user with the one or more payment tokens, and store the payment information of the one or more payment instruments of the user and the one or more payment tokens in a token data store.

2. The payment token system of claim 1, wherein:
the token creation device includes a first machine learning model, and
prior to transmitting, by the application to the payment facilitator device, the request of payment information, the first machine learning model determines whether the user has the one or more payment instruments and where the one or more payment instruments are located.

3. The payment token system of claim 2, wherein the first machine learning model determines whether the user has the one or more payment instruments and where the one or more payment instruments are located, includes:
receiving history transaction data of the user;
receiving credit report data of the user;
receiving bank specific data associated with the user;
receiving mortgage data of the user;
receiving loan data of the user;
performing a machine learning algorithm; and
determining the one or more payment instruments associated with the user and their locations.

4. The payment token system of claim 1, wherein the application is further configured to receive from the payment facilitator device one or more step-up methods associated with the one or more payment instruments of the user.

5. The payment token system of claim 4, wherein the application is further configured to transmit the one or more step-up methods to the merchant device.

6. The payment token system of claim 4, wherein the one or more step-up methods include a Short Message Service (SMS) message to a phone number of the user, a one-time passcode to the phone number of the user, and a tap of a contactless card.

7. The payment token system of claim 1, wherein:
the token creation device includes a second machine learning model; and
the second machine learning model generates a ranking of the one or more payment tokens associated with the one or more payment instruments.

8. The payment token system of claim 7, wherein the second machine learning model generates a ranking of the one or more payment tokens associated with the one or more payment instruments, includes:
receiving transaction history data of the user;
receiving merchant data associated with the merchant device;
receiving bank data associated with the user;
receiving payment instrument feature data of the one or more payment instruments;
receiving user preference data of the user;
performing a machine learning algorithm; and
determining the ranking of the one or more payment tokens.

9. The payment token system of claim 7, wherein:
the ranking is indicative of a preference order by the user of the one or more payment instruments.

10. The payment token system of claim 7, wherein:
the ranking is indicative of a recommendation order by the merchant device of the one or more payment instruments.

11. The payment token system of claim 7, wherein:
the ranking is indicative of a recommendation order by the token creation device of the one or more payment instruments.

12. The payment token system of claim 7, wherein the ranking is generated based on usage history of the one or more payment instruments, features associated with the one or more payment instruments, or a transaction pattern of the user.

13. The payment token system of claim 7, wherein the application is configured to transmit the ranking of the one or more payment tokens to the merchant device.

14. A payment token method, comprising:
receiving, by an application executing on a token creation device from a merchant device, a request to create one or more payment tokens associated with a personal identifier of a user;
in response to the request, creating, by the application, the one or more payment tokens without a payment instrument attached to the one or more payment tokens;
transmitting, by the application to the merchant device, the one or more payment tokens;
transmitting, by the application to a payment facilitator device, a request of payment information of one or more payment instruments of the user, the request including the personal identifier of the user;
receiving, by the application device from the payment facilitator device, the payment information of the one or more payment instruments of the user;
in response to receiving the payment information, associating, by the application, the payment information of the one or more payment instruments of the user with the one or more payment tokens; and
storing, by the application, the payment information of the one or more payment instruments of the user and the one or more payment tokens in a token data store.

15. The payment token method of claim 14, wherein the personal identifier of the user is generated in response to signing in or singing up by the user for a merchant account using a phone number or email address of the user.

16. The payment token method of claim 14, wherein the payment instrument includes at least one selected from a group consisting of a credit card, a debit card, a gift card, a shopping card, and a bank account.

17. The payment token method of claim 14, wherein:
the token creation device is associated with a bank, a payment processor, a payment network, or a merchant; and
the one or more tokens are associated with the bank, the payment processor, the payment network, or the merchant.

18. A non-transitory computer-readable medium having computer-executable instructions stored thereon that, when executed by a token creation device comprising a processor, cause the token creation device to perform procedures comprising:
receiving, from a merchant device, a request to create one or more payment tokens associated with a personal identifier of a user;
in response to the request, creating the one or more payment tokens without a payment instrument attached to the one or more payment tokens;
transmitting the one or more payment tokens to the merchant device;
transmitting, to a payment facilitator device, a request of payment information of one or more payment instruments of the user, the request including the personal identifier of the user;
receiving, from the payment facilitator device, the payment information of the one or more payment instruments of the user;
in response to receiving the payment information, associating the payment information of the one or more payment instruments of the user with the one or more payment tokens; and
storing the payment information of the one or more payment instruments of the user and the one or more payment tokens in a token data store.

19. The non-transitory computer-readable medium of claim 18, wherein the instructions further cause the token creation device to perform procedures comprising verifying the user based on the personal identifier of the user.

20. The non-transitory computer-readable medium of claim 18, wherein the payment information of the one or more payment instruments of the user includes a card number of a card, a bank account number associated with the card, an expiration date of the card, a card verification value of the card, or a billing address of the user.
